(19) United States
(12) Patent Application Publication
(10) Pub. No.: US 2024/0002096 A1
(43) Pub. Date: Jan. 4, 2024

(54) METHOD AND APPARATUS FOR SPLICING

(71) Applicant: UPM Raflatac Oy, TAMPERE (FI)

(72) Inventors: Ari SALMINEN, Helsinki (FI); David HIBBS, Helsinki (FI); Kai HEINONEN, Helsinki (FI); Markus PÄÄKKÖNEN, Helsinki (FI); Jorma HENTTONEN, Helsinki (FI); Atso RUOTSALAINEN, Helsinki (FI); Jarkko TIENHAARA, Helsinki (FI)

(21) Appl. No.: 17/855,855

(22) Filed: Jul. 1, 2022

(51) Int. Cl. B65C 9/00; B65C 9/18

(52) U.S. Cl. CPC B65C 9/0015; B65C 2009/0018; B65C 2009/0071; B65C 9/1892

(57) ABSTRACT

An apparatus for producing reels of adhesive label laminate, the apparatus comprising a transfer device, the transfer device comprising:
a transfer unit, which comprises a perforating blade, and a transfer surface,
an adhesive applicator unit for providing an adhesive layer on the transfer surface,
a motor to rotate the transfer unit about a first rotation axis,
an actuator unit to move the first rotation axis from a standby position to a cutting position,
   wherein the transfer device is arranged to form a perforation in the label laminate by cutting with the blade of the rotating transfer unit when the first rotation axis is in the cutting position,
   wherein the transfer device is arranged to form an adhesive region on the label laminate by pressing the transfer surface of the rotating transfer unit onto the label laminate such that the adhesive layer is transferred to the label laminate, wherein the transfer device is arranged to move the first rotation axis back to the standby position.

### FIELD

Some embodiments relate to joining a label laminate to a reel core, so as to enable winding a reel. Some embodiments relate to forming a splicing region, which enables joining a label laminate to a reel core. Some embodiments relate to winding a label laminate on a reel core.

### BACKGROUND

Adhesive label laminate may be stored and transported as reels. Producing a reel may comprise joining a leading edge of label laminate to a core of the reel, and subsequently winding the label laminate on the core. Producing a second reel may be started after the winding of a first reel has been stopped. The label laminate is typically joined to the reel core manually. The label laminate may be joined to the reel core e.g. by using double-sided adhesive tape. The movement of the label laminate may need to be stopped when forming the joint manually. Manual joining may be slow, may involve risk of positioning errors, may cause crimples, and/or may cause considerable loss of the label laminate material.

### SUMMARY

An object is to provide an apparatus for forming a splicing region, which enables joining a label laminate to a reel core. An object is to provide a method for forming a splicing region, which enables joining a label laminate to a reel core. An object is to provide an apparatus for forming reels of label laminate. An object is to provide a method for forming reels of label laminate. An object is to provide a label laminate reel.

According to an aspect, there is provided an apparatus for producing reels of adhesive label laminate, the apparatus comprising a transfer device, the transfer device comprising:
a transfer unit, which comprises a perforating blade, and a transfer surface,
an adhesive applicator unit for providing an adhesive layer on the transfer surface,
a motor to rotate the transfer unit about a first rotation axis,
an actuator unit to move the first rotation axis from a standby position to a cutting position,
   wherein the transfer device is arranged to form a perforation in the label laminate by cutting with the blade of the rotating transfer unit when the first rotation axis is in the cutting position,
   wherein the transfer device is arranged to form an adhesive region on the label laminate by pressing the transfer surface of the rotating transfer unit onto the label laminate such that the adhesive layer is transferred to the label laminate,
   wherein the transfer device is arranged to move the first rotation axis back to the standby position.

According to an aspect, there is provided a method for producing reels of adhesive label laminate by using a transfer unit, which comprises a perforating blade, and a transfer surface,

the method comprising:
providing an adhesive layer on the transfer surface of the transfer unit,
rotating the transfer unit about a first rotation axis,
moving the first rotation axis from a standby position to a cutting position,
forming a perforation in the label laminate by cutting with the blade of the rotating transfer unit when the first rotation axis is in the cutting position,
forming an adhesive region on the label laminate by pressing the transfer surface of the rotating transfer unit onto the label laminate such that the adhesive layer is transferred to the label laminate, and
moving the first rotation axis back to the standby position.

According to an aspect, there is provided a reel, comprising:
a reel core, and
a label laminate wound on the reel core,
   wherein a broken splicing region of the label laminate is joined to the reel core by an adhesive joint,
   wherein the adhesive joint is formed by an adhesive region between the reel core and a major surface of the label laminate, wherein the broken splicing region comprises the adhesive region, and wherein the broken splicing region comprises an edge formed by breaking a perforation of the label laminate.

The scope of protection sought for various embodiments of the invention is set out by the independent claims. The embodiments, if any, described in this specification that do not fall under the scope of the independent claims are to be interpreted as examples useful for understanding various embodiments of the invention.

The present method may allow producing a plurality of reels from a label laminate as a continuous process.

The laminate may be wound on a first reel core to form a first reel. The method comprises forming a splicing region on the laminate when the laminate is moving, wherein the splicing region comprises a perforation and an adhesive region. The adhesive region forms an adhesive joint between the moving laminate and a second rotating reel core. The moving laminate may be continuously pulled to the first reel, while the adhesive joint formed with the rotating second core breaks the perforation. Breaking of the perforation forms a leading edge of the laminate and a trailing edge of the laminate. The leading edge may start to rotate together with the second core, thereby starting a first laminate layer on second core. The trailing edge is pulled to the first reel. The trailing edge terminates the outermost layer of the laminate of the first reel.

A rotating transfer unit of the apparatus comprises a blade for forming a perforation in the laminate, and a transfer surface for forming an adhesive region on the laminate. The blade and the transfer surface rotate together with the transfer unit. The perforation and the adhesive region may be formed on the moving laminate during a single rapid rotational movement of the transfer unit.

The adhesive layer may be formed on the transfer surface e.g. by a hot melt gun, and the transfer surface may subsequently release the adhesive layer to the laminate. The transfer surface may also be called e.g. as a release surface.

The transfer unit may be implemented e.g. as a knife roll. The knife roll may comprise the perforating blade and the transfer surface. A layer of adhesive may be applied to the transfer surface of a transfer unit e.g. by using a hot melt applicator unit. The applicator unit may apply a stripe of hotmelt adhesive to the transfer surface on the knife roll. The knife roll may perforate the web and may apply said stripe of adhesive to the laminate in one movement when triggered to splice.

The transfer unit may be stationary when applying the adhesive. Alternatively, the transfer unit may be turned at a slow speed in order to facilitate applying the adhesive to the transfer surface. The blade and the transfer surface may be e.g. V-shaped (FIG. 8a), wherein the transfer unit may be turned in order to facilitate applying the adhesive to the V-shaped transfer surface.

After adding the adhesive layer, the rotation of the transfer unit may be accelerated to correspond to the velocity of the moving laminate. The axis of rotation may be at a standby position during the acceleration, so as to avoid premature cutting of the laminate. After the target speed of rotation has been attained, the axis of rotation of the transfer unit may be rapidly moved from the standby position to a cutting position closer to the moving laminate.

The blade may contact the laminate when the axis of the rotating transfer unit is in the cutting position. The blade of the rotating transfer unit may penetrate the laminate. The blade of the rotating transfer unit may form the perforation when the contacting blade cuts through the moving laminate. The laminate may be positioned between the transfer unit and a rotating backing roll. The laminate may be positioned between the blade and the backing roll. The blade may perforate the laminate by contacting the backing roll through the laminate.

After the perforating blade has been brought into contact with the laminate, the transfer surface may be pressed against the moving laminate, so as to transfer the layer of adhesive from the transfer surface to the moving laminate. The transfer surface may form an adhesive region on the laminate by transferring the adhesive layer to the laminate. The transfer surface may release the adhesive layer to the laminate. The transfer surface may also be called e.g. as a release surface.

The laminate may be located between the transfer surface and the backing roll when forming the adhesive region. The laminate may be pressed between the transfer surface and the backing roll, so as to transfer the layer of adhesive from the transfer surface to the moving laminate. The transfer surface may be pressed against the moving laminate before the axis of rotation of the transfer unit is moved back to the standby position.

The method may allow improved control of the position of the adhesive joint with respect to the leading edge of the laminate, thereby improving the reliability of splicing at a rewinder. The method may reduce the amount of wasted laminate, thanks to more controlled start of a new reel. For example, the method may reduce the amount of wasted laminate by reducing a risk of forming creases in the laminate, which is wound on the reel core. The method may provide cost savings due to the more controlled start of a new reel.

The method may provide a crease-free splicing process to a rewinder. The laminate may be perforated and provided with the splicing adhesive region in the same process, before entering the rewinder.

The present method may allow significant reduction of the amount of laminate material wasted when performing a splicing operation.

In an embodiment, the transfer device may be installed into an existing production line, so as to speed up production and/or to improve operating reliability.

The present method may avoid the need to stop movement of the laminate for performing a splicing operation. The present method allows uninterrupted winding e.g. when the transfer device is used together with a turret rewinder. The turret rewinder may simultaneously hold two or more reel cores, wherein the laminate may be wound on a first reel and later on a second reel without a need to stop movement of the laminate when starting the winding on the second reel.

As a comparative example, a manual splicing operation may require stopping of the movement of the laminate and may take e.g. more than 30 minutes per reel. As a comparative example, when performing splicing as a manual operation, an adhesive tape is typically applied around the whole circumference of a reel core, and the length of a laminate wasted in a comparative manual splicing operation may even be greater than the circumference of the reel core.

### BRIEF DESCRIPTION OF THE DRAWINGS

In the following examples, several variations will be described in more detail with reference to the appended drawings, in which

FIG. 1a shows, by way of example, in a side view, a winding apparatus, which comprises a transfer device and a winding device,

FIG. 1b shows, by way of example, in a three-dimensional view, a transfer device,

FIG. 2 shows, by way of example, method steps for producing reels from adhesive label laminate,

FIG. 3a shows, by way of example, a timing diagram for producing reels from adhesive label laminate,

FIG. 3b shows, by way of example, movement of a rotation axis of the transfer unit when preparing the laminate for the joint,

FIG. 4a shows, by way of example, in a side view, applying a layer of adhesive on the transfer unit,

FIG. 4b shows, by way of example, in a side view, rotation of the transfer unit during acceleration,

FIG. 4c shows, by way of example, in a side view, perforating the laminate with a perforating blade of the transfer unit,

FIG. 4d shows, by way of example, in a side view, transferring the layer of adhesive from the transfer unit to the laminate,

FIG. 5a shows, by way of example, in a side view, a splicing region of the laminate before a contact with a core,

FIG. 5b shows, by way of example, in a side view, a splicing region of the laminate, which has adhered to the core,

FIG. 5c shows, by way of example, in a side view, the leading edge and the trailing edge of the laminate after the leading edge has been pulled apart from the trailing edge,

FIG. 5d shows, by way of example, in a side view, mounting a new core to the winding device during rotation of the second reel,

FIG. 6a shows, by way of example, in a frontal view, the transfer device,

FIG. 6b shows, by way of example, in a top view, the transfer device,

FIGS. 7a to 7c show, by way of example, in a side view, using an eccentric actuating element for causing a movement of the rotation axis of the transfer unit,

FIG. 8a shows, by way of example, in a frontal view, a transfer unit,

FIG. 8b shows, by way of example, a cross-section of the transfer unit,

FIG. 8c shows, by way of example, a cross-section of the transfer unit,

FIG. 9a shows, by way of example, in a side view, dimensions of the transfer unit,

FIG. 9b shows, by way of example, in a side view, an angular height of the combination of the blade and the transfer surface,

FIG. 10a shows, by way of example, a splicing region, which is perpendicular to the longitudinal direction of the laminate,

FIG. 10b shows, by way of example, a splicing region, which is inclined with respect to the longitudinal direction of the laminate,

FIG. 10c shows, by way of example, a V-shaped splicing region,

FIG. 10d shows, by way of example, a cross-section of the adhesive label laminate,

FIG. 11a shows, by way of example, a splicing region,

FIG. 11b shows, by way of example, a broken splicing region,

FIG. 12a shows, by way of example, in a frontal view, a reel produced by the winding apparatus,

FIG. 12b shows, by way of example, in a side view, the reel of FIG. 12a,

FIG. 12c shows, by way of example, in a frontal view, a trailing edge of the reel of FIG. 12a,

FIG. 12d shows, by way of example, in a side view, a second reel,

FIG. 13 shows, by way of example, a control system of the winding apparatus, and

FIG. 14 shows, by way of example, in a frontal view, a turret winder.

### DETAILED DESCRIPTION

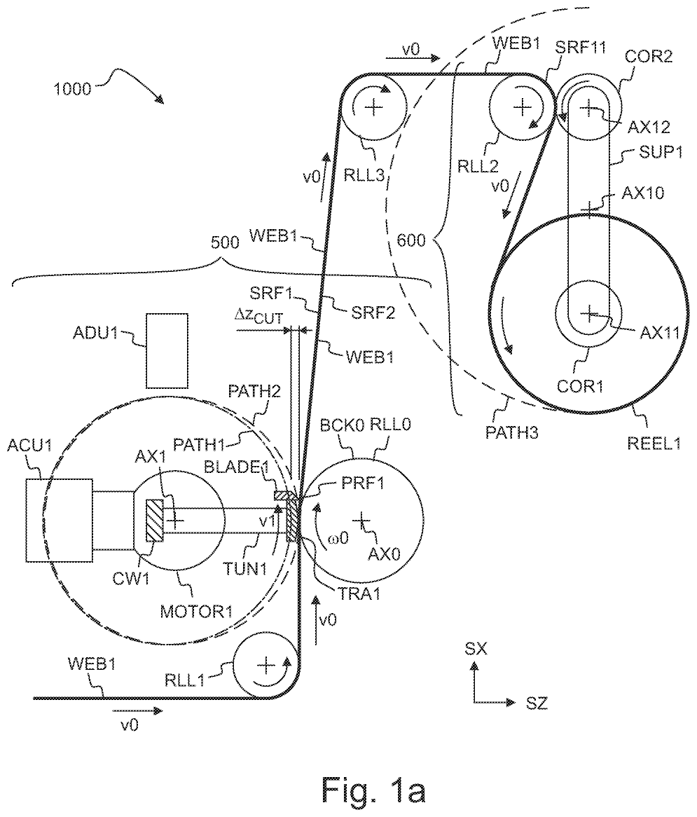

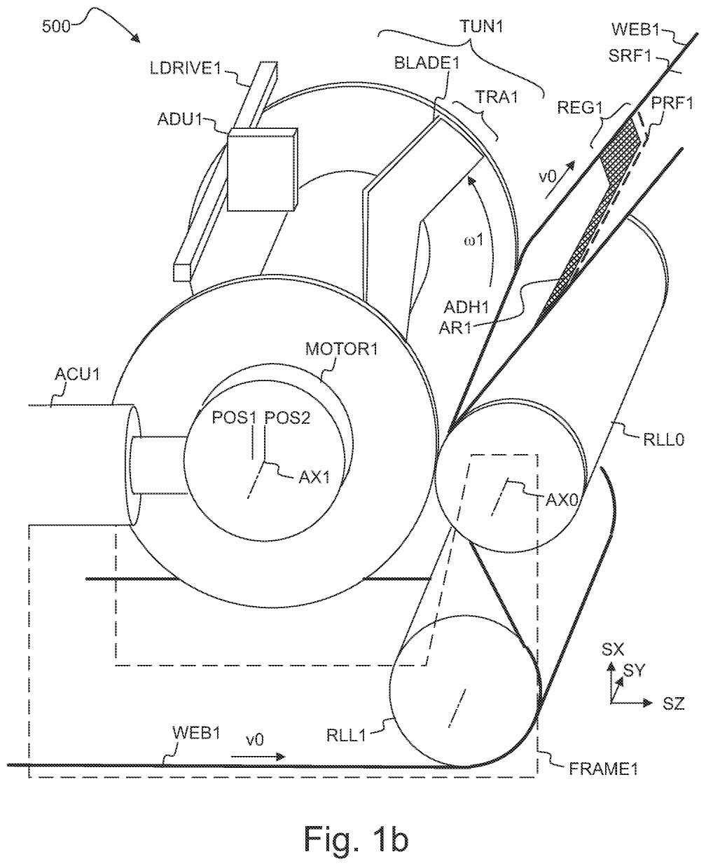

Referring to FIGS. 1a and 1 b, a winding apparatus 1000 may comprise a transfer device 500 and a winding device 600.

The transfer device 500 may form a splicing region REG1 on the label laminate WEB1. The splicing region REG1 comprises a perforation PRF1 and an adhesive region AR1. The adhesive region AR1 comprises an adhesive layer ADH1 attached to the major surface SRF1 of the label laminate WEB1.

The winding device 600 may be arranged to form a first reel REEL1 of label laminate WEB1 by winding the label laminate WEB1 on a first reel core COR1, and to form a second reel REEL2 of label laminate WEB1 by winding the label laminate WEB1 on a second reel core COR2.

The transfer device 500 comprises a rotating transfer unit TUN1, which comprises a perforating blade BLADE1, and a transfer surface TRA1. The blade BLADE1 may form a perforation in the laminate WEB1. The transfer surface TRA1 may temporarily carry an adhesive layer ADH1, which may be transferred to the surface SRF1 of the laminate WEB1 so as to form the splicing region REG1 on the label laminate WEB1.

The transfer device 500 may comprise an adhesive applicator unit ADU1 to provide an adhesive layer ADH1 on the transfer surface TRA1 of the transfer unit TUN1. The rotation of the transfer unit TUN1 may be stopped when forming the adhesive layer ADH1 on the transfer surface TRA1.

The adhesive ADH1 may be applied e.g. as a hot melt adhesive. The hot melt adhesive is solid at the normal room temperature (25° C.). The hot melt adhesive may be converted into liquid form by heating. The hot melt adhesive may include thermoplastic elastomer(s), e.g. styrene block polymer(s).

The adhesive layer ADH1 may be applied to the transfer surface TRA1 also by e.g. spraying. The adhesive layer ADH1 may also be formed e.g. by dispensing two-sided adhesive tape to the transfer surface TRA1.

The properties of the adhesive layer ADH1 and the properties of the transfer surface TRA1 may be selected such that the adhesive layer ADH1 may remain adhered to the transfer surface TRA1 during rotation of the transfer unit TUN1, wherein the adhesive layer ADH1 may be released from the transfer surface TRA1 to the laminate WEB1 when the transfer surface TRA1 is pressed against the laminate WEB1. The transfer surface TRA may comprise e.g. fluoropolymer or silicone to facilitate releasing the adhesive layer ADH1.

The transfer unit TUN1 is arranged to rotate about a first rotation axis AX1. The blade BLADE1 and the transfer surface TRA1 rotate together with the transfer unit TUN1. The transfer unit TUN1 may optionally comprise one or more counterweights CW1 to balance the rotating mass of the transfer unit TUN1. The transfer device 500 may comprise a motor MOTOR1 for rotating the transfer unit TUN1 about the first rotation axis AX1.

The rotation of the transfer unit TUN1 may be started and accelerated when the first rotation axis AX1 is at a standby position POS1. The distance between the standby position POS1 and the moving laminate WEB1 may be selected such that the blade BLADE1 and the transfer surface TRA1 do not contact the laminate WEB1 during the acceleration.

The rotation speed of the transfer unit TUN1 may be selected and controlled such that the tangential velocity v1 of the blade BLADE1 is equal to the velocity v0 of the laminate WEB1. The position of the first rotation axis AX1 may be changed after the angular velocity ω1 of the rotating transfer unit TUN1 corresponds to the velocity v0 of the moving laminate WEB1.

The transfer device 500 may comprise an actuator unit ACU1 to move the first rotation axis AX1 rapidly from the standby position POS1 to a cutting position POS2. The first rotation axis AX1 may be moved in the direction SZ so as to reduce the distance between the first rotation axis AX1 and the moving laminate WEB1. The first rotation axis AX1 may be moved in the direction SZ to the cutting position POS2 so as to allow the blade BLADE1 of the rotating transfer unit TUN1 to contact and penetrate the laminate WEB1. The standby position POS1 may be associated with a position coordinate z₁. The cutting position may be associated with a position coordinate z₂. Azcur may denote a distance between the positions POS1 and POS2. The blade BLADE1 may move along a first path PATH1 during standby operation. The blade BLADE1 may move along a second path PATH2 for forming the perforation and for transferring the adhesive layer ADH1.

The actuator unit ACU1 may move the axis AX1 from the standby position POS1 to the cutting position POS2, and from the cutting position POS2 back to the standby position POS1. The actuator unit ACU1 may move the axis AX1 back to the standby position after the adhesive region has been formed.

The weight of the rotating transfer unit TUN1 may be e.g. in the range of 20 kg to 2000 kg. The actuator unit ACU1 may be arranged to generate a sufficient force for moving the rotation axis AX1 from the standby position POS1 to the cutting POS2 in a time period, which is substantially shorter than the time period of one complete rotation (360°) of the transfer unit TUN1. In particular, the actuator unit ACU1 may be arranged to generate a sufficient force for moving the rotation axis AX1 from the standby position POS1 to the cutting POS2 in a time period, which is shorter than or equal to the time period of one half rotation (180°) of the transfer unit TUN1.

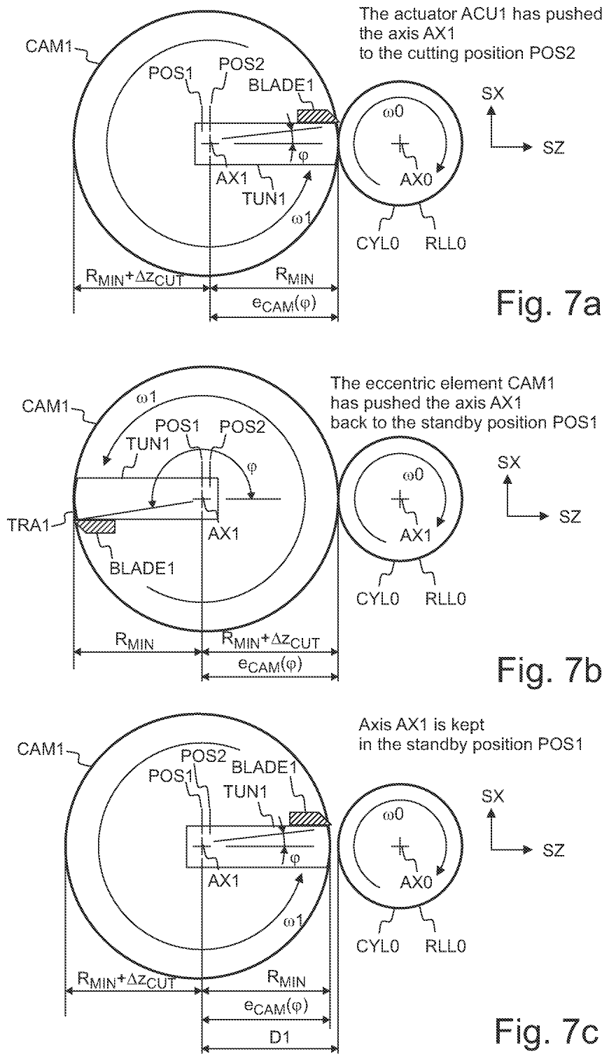

The actuator unit ACU1 may comprise e.g. one or more pneumatic actuators. The actuator unit ACU1 may comprise e.g. one or more electromagnetic actuators. The actuator unit ACU1 may comprise e.g. one or more hydraulic actuators. Yet, the actuator unit ACU1 may comprise an eccentric actuating element (FIG. 7a) to push the first rotation axis AX1 away from the cutting position POS2 after the perforation PRF1 has been formed.

SX, SY, and SZ denote orthogonal directions.

The laminate WEB1 may move in the direction SX at the backing roll RLL0. The direction SX may also denote the longitudinal direction of the laminate WEB1. The velocity v0 of the laminate WEB1 may be e.g. in the range of 1 m/s to 30 m/s. For example, the velocity v0 of the laminate WEB1 may be e.g. approximately equal to 20 m/s (1200 m/min)

The laminate WEB1 has a first major surface SRF1 and a second major surface SRF2. The adhesive layer ADH1 may be transferred to the first major surface SRF1.

The laminate WEB1 may move in the winder device 600 so that the first major surface SRF1 is in contact with the reel core COR2. The perforation PRF1 and the adhesive region AR1 may move towards the reel core COR2 until the adhesive layer ADH1 sticks to the core COR2. The adhesive region AR1 forms an adhesive joint between the laminate WEB1 and core COR1. The adhesive joint may start to rotate together with the core COR2. The rotation of the adhesive joint together with the core COR2 may subsequently break the perforation PRF1. The reel REEL2 may be formed by winding the laminate WEB1 on the core COR2.

The winder device 600 may allow removing a first reel REEL1 during rotation of the second reel REEL2. The adhesive joint between the splicing region REG1 and a core COR2 may be formed at the full velocity v₀ of the moving web WEB1. The breaking of the perforation may take place at the full velocity v₀ of the moving laminate WEB1. The apparatus 1000 may allow continuous operation during the splicing operation.

The winder device 600 may comprise a support SUP1 to hold and rotate a first reel core COR1, and to hold and rotate a second reel core COR2. The winder device 600 may comprise a motor to rotate the first reel core COR1 about an axis AX11. The winder device 600 may comprise a motor to rotate the second reel core COR2 about an axis AX12. For breaking the perforation PRF1, the cores COR1, COR2 may be rotated simultaneously. Rotation of the first reel REEL1 may be stopped for removing the first reel REEL1, during rotation of the second reel REEL2. A new reel core (COR1′) may be mounted to the axis AX11. The positions of the axes AX11, AX12 may be interchanged e.g. by turning the support SUP1 about an axis AX10 with an actuator (M10). Consequently, an almost finished reel REEL2 may be moved to a position where the reel REEL2 may be removed from the winder device 600, wherein the new reel core COR1′ may be brought into contact with the surface SRF1 of the moving laminate WEB1. The reel REEL2 may be moved e.g. along a path PATH3. Rotation of the second reel REEL2 may be stopped for removing the second reel REEL2, during rotation of the first reel REEL1.

The apparatus 1000 may comprise a backing roll RLL0 to operate as a backing for the blade BLADE1 and/or to operate as backing for the transfer surface TRA1. The backing roll RLL0 may have a backing surface BCKO to support the laminate WEB1 when forming the perforation PRF1 with the blade BLADE1 and when pressing the laminate WEB1 with the transfer surface TRA1. The backing surface BCKO may define the position of the laminate WEB1 in the direction SZ. The backing roll RLL0 may rotate about a rotation axis AX0. In an embodiment, the blade BLADE1 contact the backing roll RLL0 when cutting through the laminate WEB1.

The transfer device 500 may press the laminate WEB1 between the transfer surface TRA1 and the backing roll RLL0.

The apparatus 1000 may optionally comprise additional rolls RLL1, RLL2, RLL3 e.g. to guide the moving laminate WEB1, to define the position of the moving laminate WEB1, to control tension of the laminate WEB1 and/or to press the laminate WEB1 against a core COR2.

The apparatus 1000 may be arranged to operate such that the adhesive layer ADH1 and the first major surface SRF1 do not contact any roll or any other part of the apparatus between the transfer unit TUN1 and the reel core COR2, in order to avoid premature sticking.

The adhesive label laminate WEB1 may be obtained e.g. from a laminate production apparatus. The adhesive label laminate WEB1 may be obtained directly from a label laminate manufacturing process. A method of producing label laminate WEB1 may comprise forming the splicing regions REG1 and/or winding the laminate WEB1 on the reel cores COR1, COR2.

The adhesive label laminate WEB1 may be obtained e.g. from a primary reel. The primary reel may be e.g. a jumbo reel. The method may comprise unwinding the laminate WEB1 from a primary reel. The winder device 600 may operate as a rewinder.

FIG. 1b shows, by way of example, a transfer device 500, and a splicing region REG1 formed on the moving laminate WEB1.

The backing roll RLL0 and the actuator unit ACU1 may be supported e.g. by a frame FRAME1. The bearings and/or a shaft of the backing roll RLL0 may be attached to the frame FRAME1.

The adhesive applicator unit ADU1 may be arranged to move e.g. in the transverse direction SY e.g. by using a linear actuator LDRIVE1, when forming the adhesive layer ADH1 on the transfer surface TRA1.

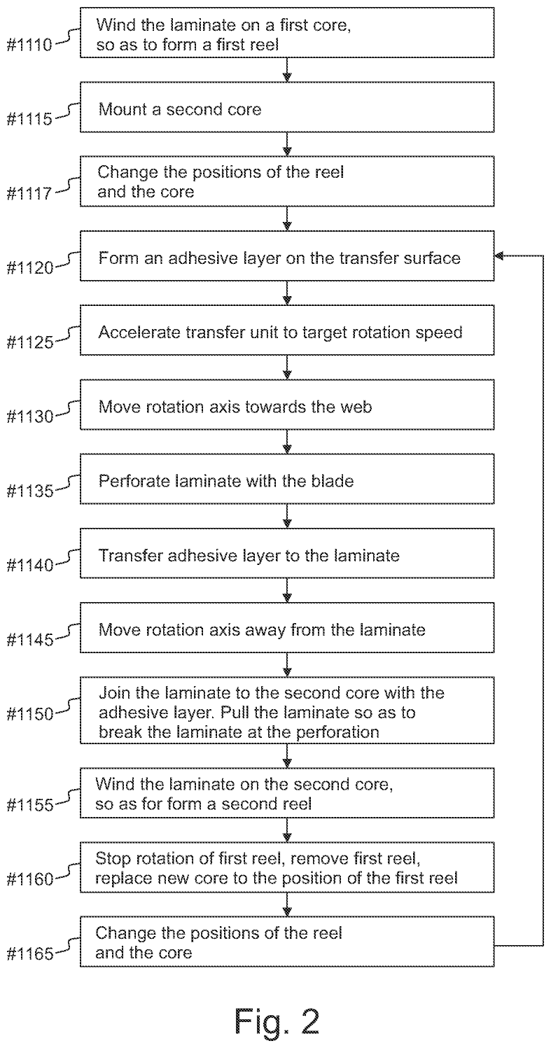

FIG. 2 shows, by way of example, method steps for winding the laminate WEB1 on reel cores COR1, COR2.

The laminate may be wound on a first core COR1 so as to form a first reel REEL1 (step #1110).

A second core COR2 may be mounted to the winder device 600 (step #1115).

The positions of the first reel REEL1 and the second core COR2 may be changed or interchanged (step #1117). In particular, the empty second core COR2 may be moved to a position, where the second core COR2 may form an adhesive joint with the splicing region REG1. The first reel REEL1 may be moved to a position where the trailing edge of the laminate may be wound on the first reel REEL1 after the perforation of the splicing region REG1 has been broken.

Rotation of the second core COR2 may be started before the second core COR2 contacts the laminate WEB1. The rotation speed of the second core COR2 may be selected and controlled such that the rotation speed of the second core COR2 matches the velocity v0 of the laminate.

An adhesive layer ADH1 may be provided on the transfer surface TRA1 of the transfer unit TUN1 (step #1120).

The transfer unit TUN1 may be accelerated to the target speed, which corresponds to the velocity of the laminate WEB1 (step #1125).

The rotation axis AX1 of the rotating transfer unit TUN1 may be rapidly moved towards the moving laminate WEB1 (step #1130).

The blade BLADE1 of the rotating transfer unit TUN1 may perforate the moving laminate WEB1 when the rotation axis AX1 is in the cutting position POS2 (step #1135).

The transfer surface TRA1 may be pressed against the moving laminate WEB1 so as to transfer the adhesive layer ADH1 from the transfer surface TRA1 to the surface SRF1 of the laminate WEB1 (step #1140).

The rotation axis AX1 of the transfer unit TUN1 may be moved away from the cutting position POS2 (step #1145).

The splicing region REG1 formed on the moving laminate WEB1 may travel together with the moving laminate WEB1 towards the reel core COR2. The adhesive layer of the splicing region REG1 may adhere to the rotating reel core COR2 so that the perforation PRF1 is broken (step #1150).

The laminate WEB1 may be wound on the reel core COR2 so as to form a second reel REEL1 of laminate WEB1 (step #1155).

Rotation of the first reel REEL1 may be stopped, the first reel REEL1 may be removed from the winder device 600, and a new empty core (COR1′) may be mounted to the winder device 600 during continuous winding of the laminate WEB1 on the second reel core COR2 (step #1160).

The positions of the axes AX11, AX12 may be changed or interchanged after the new reel core (COR1′) has been mounted (step #1165). In particular, the new empty reel core COR1′ may be moved to a position, where the empty core COR1′ may form an adhesive joint with the next splicing region REG1. The second reel REEL2 may be moved to a position where the trailing edge of the laminate may be wound on the second reel REEL2 after the perforation of the next splicing region REG1 has been broken.

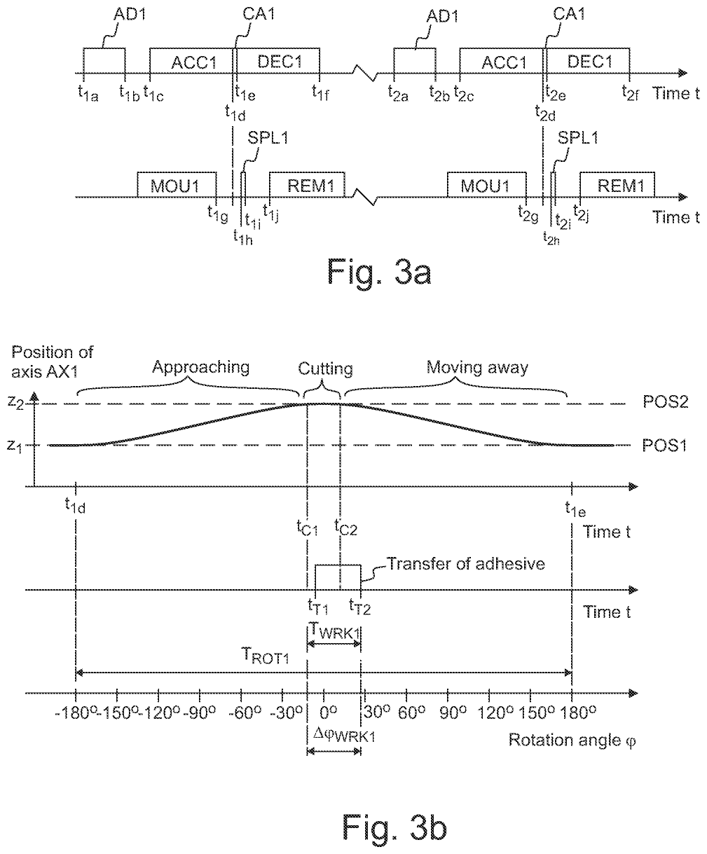

FIG. 3a shows, by way of example, a timing diagram for forming a splicing region REG1 on the moving laminate WEB1.

The transfer device 500 may be arranged to perform a reciprocating movement of the rotation axis AX1, where the axis AX1 first moves from the standby position towards the laminate WEB1, reaches the cutting position, and then moves away from the laminate WEB1 back to the standby position. The transfer device 500 may be arranged to perform said reciprocating movement in a time period, which is shorter than the time period T_{ROT1} of one complete rotation of the transfer unit TUN1.

The rotation axis AX1 of the transfer unit TUN1 may be moved away from the cutting position POS2 after forming the perforation PRF1. The rotation axis AX1 may be moved back to the standby position before the next rotation of the transfer unit TUN1 begins. This may ensure that the transfer device 500 forms only one splicing region REG1 for each new reel core (COR2, COR1′).

An adhesive layer ADH1 may be provided on the transfer surface TRA1 between times t₁ₐ, t_{1b} in an adhesive application operation AD1.

The rotation of the transfer unit TUN1 may be accelerated between times t_{1c}, t_{1d} in an accelerating operation ACC1.

The perforation PRF1 may be formed and the adhesive layer ADH1 may be transferred between times t_{1d} and t₁ₑ in a combined operation CA1, so as to form a splicing region REG1.

The rotation of the transfer unit TUN1 may be decelerated between times t₁ₑ, t_{1f} in a decelerating operation DEC1.

A new reel core may be mounted in a mounting operation MOU1, which may end at a time t_{1g}.

The adhesive layer ADH1 of the splicing region REG1 may stick to the reel core COR2 and the perforation PRF1 may break between times t₁ₕ and t₁ᵢ in a splicing operation SPL1.

A finished reel REEL1 may be removed after time t₁ⱼ in a removing operation REM1.

The sequence of operations AD1, ACC1, CA1, DEC1 may be repeated at a later stage for forming a next splicing region REG1 (times t₂ₐ, t_{2b}, t_{2c}, t_{2d}, t₂ₑ, t^{2f}), which allows winding the laminate WEB1 on the new reel core COR1′. The sequence of operations MOU1, SPL1, REM1 may be repeated at a later stage for starting winding on a new core COR1′ (times t_{2g}, t₂ₕ, t₂ᵢ, t₂ⱼ).

FIG. 3b shows, by way of example, position of the rotation axis AX1 of the rotating transfer unit TUN1 as a function of time t.

The actuator ACU1 may start to move the rotation axis AX1 of the rotating transfer unit TUN1 towards the moving laminate WEB1 after the time t_{1d}, so as to move the rotation axis AX1 from the standby position POS1 (coordinate z₁) to the cutting position POS2 (coordinate z₂).

The blade BLADE1 of the rotating transfer unit TUN1 may contact the moving laminate WEB1 during a contact time period between times t_{C1} and t_{C2}. The transfer surface TRA1 may press the surface SRF1 of the moving laminate WEB1 during a transfer time period between times t_{T1} and t_{T2}. The transfer time period may partly overlap the contact time period.

The start t_{C1} of the contact time period and the end t_{T2} of the transfer time period may define a working time period T_{WRK1} of the transfer unit TUN1. A first point (FP1) of the blade BLADE1 may contact the laminate WEB1 at the time t_{C1}. The last points of the adhesive region AR1 may be formed at the time t_{T2}.

The working time period T_{WRK1} may be substantially shorter than the time period T_{ROT1} of one complete rotation of the transfer unit TUN1. Thus, actuator forces needed for performing the reciprocating movement may be reduced.

The transfer unit TUN1 may rotate at an angular speed ω1. A turning angle Δφ_{WRK1} which corresponds to the working time period T_{WRK1} may be equal to the angular speed ω1 multiplied by the working time period T_{WRK1}. The turning angle Δφ_{WRK1} may be e.g. in the range of 2° to 60°, advantageously in the range of 6° to 30°. The blade BLADE1 may turn by the angle Δφ_{WRK1} during forming the perforation PRF1 and during transfer of the adhesive layer ADH1. The turning angle Δφ_{WRK1} is substantially smaller than 360°, e.g. in the range of 2° to 60°, so as to ensure that the transfer device 500 forms only one splicing region REG1 for each new reel.

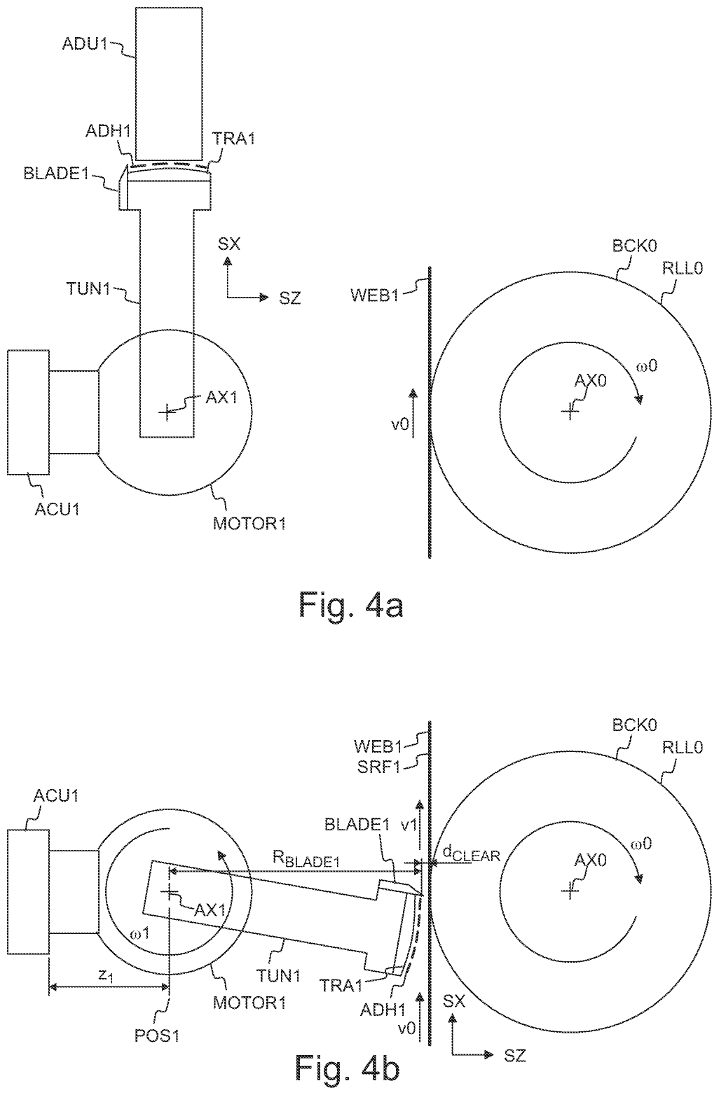

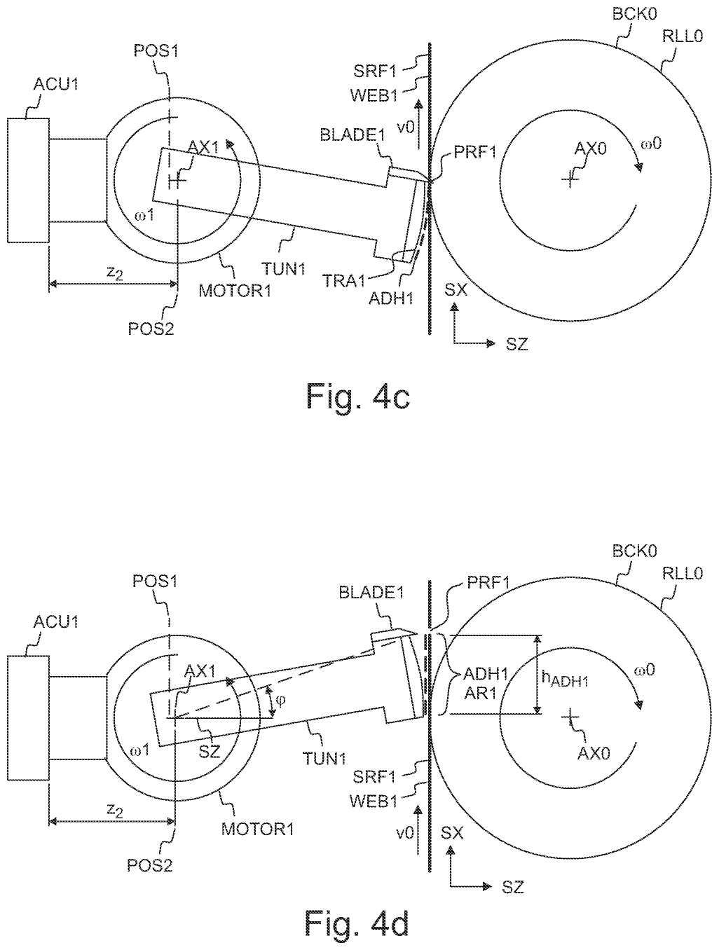

The rotation angle φ may specify the angular position of the rotating transfer unit TUN1 with respect to a reference direction, e.g. with respect to the direction SZ (see FIG. 4d). The rotation angle φ=0° may refer e.g. to the angular orientation where the center of the blade BLADE1 is closest to the axis AX0 of the backing roll RLL0.

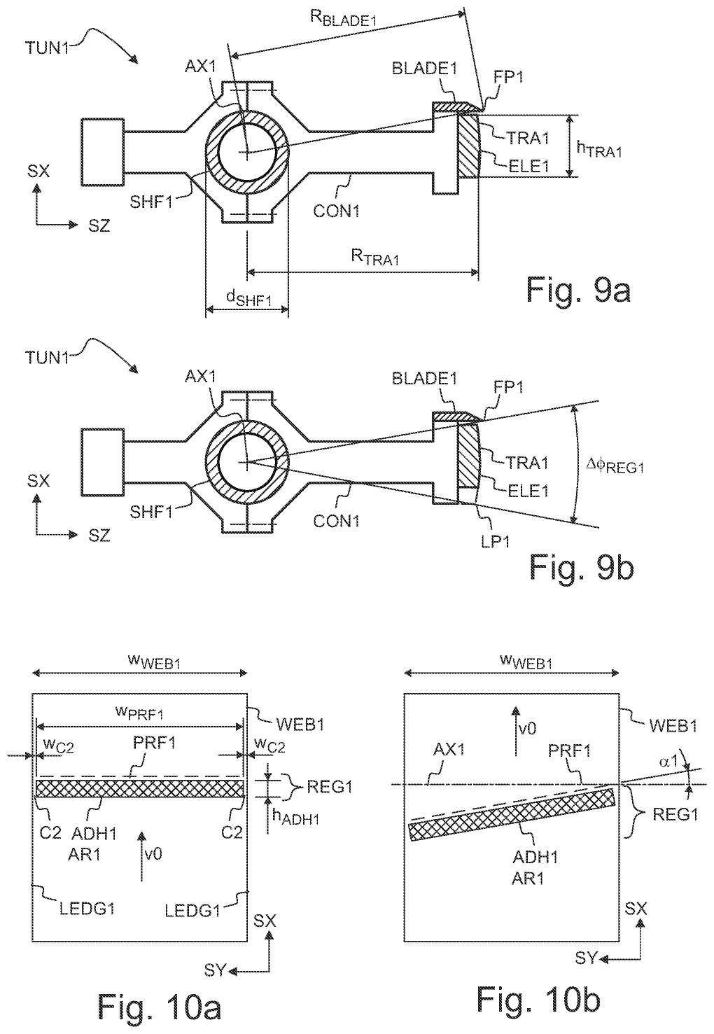

The working time period T_{WRK1} may be approximately equal to a time period needed for rotating the transfer unit TUN1 by an angle, which is equal to the angular height Δϕ_{REG1} of the combination of the blade BLADE1 and the transfer surface TRA1 (see FIG. 9b).

FIGS. 4a to 4d show operations performed with the transfer unit TUN1.

Referring to FIG. 4a, an adhesive layer ADH1 may be provided on the transfer surface TRA1 by using an adhesive applicator unit ADU1. Rotation of the transfer unit TUN1 may be stopped or significantly slowed down during applying the adhesive layer ADH1.

The transfer surface TRA1 may be moved (slowly) with the motor MOTOR1 and/or the adhesive applicator unit ADU1 may be moved with an actuator LDRIVE1 when applying the adhesive layer ADH1 on the transfer surface TRA1.

Referring to FIG. 4b, rotation of the transfer unit TUN1 may be accelerated to the target speed when the rotation axis AX1 is at the standby position POS1 so as to prevent the transfer unit TUN1 from contacting the moving laminate WEB1.

The blade BLADE1 and the transfer surface TRA1 may be parts of the rotating transfer unit TUN1. The blade BLADE1 may be fixed to the rotating transfer unit TUN1 such that the distance between the cutting edge of the BLADE1 and the axis AX1 remains constant during the operation. The blade BLADE1 may be fixed to the rotating transfer unit TUN1 e.g. by screws. The blade BLADE1 may comprise one or more blade segments.

The blade BLADE1 and the transfer surface TRA1 may rotate about the axis AX1 at the angular speed ω1 together with the transfer unit TUN1. The blade BLADE1 may rotate at a constant radial distance R_{BLADE1} from the axis AX1. The backing roll RLL0 may rotate about the axis AX0 at the angular speed ω0.

Referring to FIG. 4c, the rotation axis AX1 may be moved from the standby position POS1 to the cutting position POS2 so that the blade BLADE1 reaches to penetrate the moving laminate WEB1. The motor MOTOR1 may be controlled such that the tangential velocity v1 of the blade BLADE1 matches the velocity v0 of the moving laminate WEB1.

Referring to FIG. 4d, after the blade BLADE1 has penetrated the laminate

WEB1, the transfer unit TUN1 may continue rotation about the axis AX1 such that the curved transfer surface TRA1 may press the laminate WEB1 against the backing roll RLL0, so as to transfer the adhesive layer ADH1 from the transfer surface TRA1 to the surface SRF1 of the laminate WEB1.

The transfer surface TRA1 may transfer the adhesive layer ADH1 to the laminate WEB1, so as to form an adhesive region AR1 on the surface SRF1 of the laminate WEB1. The adhesive region AR1 comprises the transferred adhesive layer ADH1. The adhesive region AR1 may have a dimension h_{ADH1} in the longitudinal direction of the laminate WEB1. The adhesive region AR1 is located after the perforation PRF1 on the moving laminate WEB1.

The rotation axis AX1 may be moved away from the cutting position POS2 after the blade BLADE1 has penetrated the laminate WEB1. The rotation axis AX1 may be moved back to the standby position POS1 after the adhesive layer ADH1 has been transferred to the laminate WEB1.

Forming of the perforation PRF1 and transferring the adhesive layer ADH1 to the laminate WEB1 may take place during the same rotation of the transfer unit TUN1.

The transfer device 500 may be arranged to form the perforation PRF1 and to transfer the adhesive layer ADH1 during a working time period T_{WORK1} which is shorter than a time period T_{ROT1} of one complete rotation (360°) of the transfer unit TUN1.

In particular, the actuator unit ACU1 may be arranged to operate such that forming the perforation PRF1 and transferring the adhesive layer ADH1 to the laminate WEB1 may take place during a time period T_{WRK1}, which is e.g. shorter than 20% of the rotation time period TROT.

The radius R_{BLADE1} of the blade BLADE1 and the longitudinal dimension hADJi of the adhesive region AR1 may be selected to allow forming the perforation PRF1 and transferring the adhesive layer ADH1 to the laminate WEB1 during a time period T_{WRK1}, which is e.g. shorter than 20% of the rotation time TROT for one complete rotation of the transfer unit TUN1 about the axis AX1.

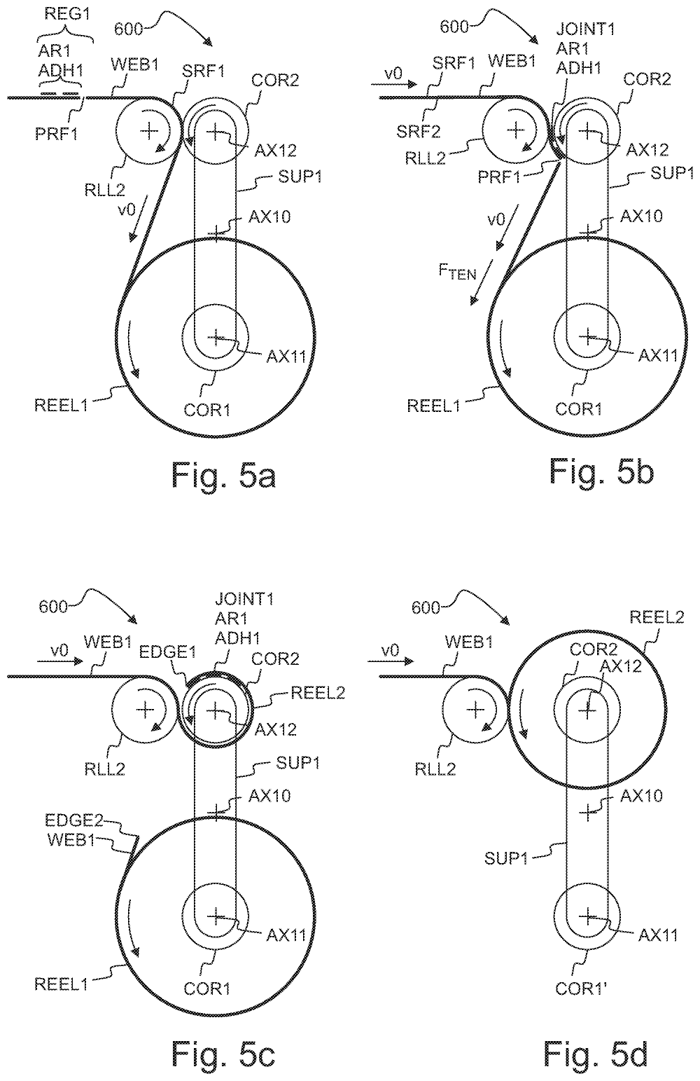

FIGS. 5a to 5d show starting the winding a second reel REEL2 and stopping the winding of a first reel REEL1, without stopping movement of the laminate WEB1.

Referring to FIG. 5a, the splicing region REG1 formed on the laminate WEB1 may approach the winding device 600. The winding device 600 may rotate the reel REEL1 about an axis AX11 and a reel core COR2 about an axis AX12.

Referring to FIG. 5b, the adhesive ADH1 of the splicing region REG1 may contact the core COR2 after the perforation PRF1 has already contacted the core COR2. The winding device 600 may press the adhesive region AR1 of the splicing region REG1 against the core COR2 so as to form an adhesive joint JOINT1 between the laminate WEB1 and the core COR2. The adhesive joint JOINT1 may begin to rotate together with the rotating core COR2. The rotating first reel REEL1 may continue pulling the laminate WEB1 towards the first reel REEL1 with a force F_{TEN}.

The winding device 600 may comprise a roll RLL2 to press the laminate WEB1 against the reel core (COR1, COR2, COR1′).

Referring to FIG. 5c, the rotating adhesive joint JOINT1 may break the perforation PRF1 together with the pulling force caused by the rotating first reel REEL1. Breaking of the perforation PRF1 may form a leading edge EDGE1 of the laminate WEB1 and a trailing edge EDGE2 of the laminate WEB1. The leading edge EDGE1 may begin to rotate together with the core COR2, so as to start forming the first turn of the second reel REEL2 on the core COR2.

The trailing edge EDGE2 may be pulled to the first reel REEL1. The trailing edge EDGE2 may terminate the last turn of the laminate WEB1 wound on the reel REEL1.

The method may comprise:
forming the first reel REEL1 by winding the label laminate WEB1 on the first reel core COR1,
forming the adhesive joint JOINT1 by bringing the adhesive region AR1 into contact with the rotating second reel core COR2 when the label laminate WEB1 is wound on the first reel REEL1,
breaking the perforation PRF1, and
forming the second reel REEL2 by winding the label laminate WEB1 on the second reel core COR1, wherein the second reel REEL2 comprises the adhesive joint JOINT1 and the leading edge EDGE1 formed by breaking the perforation PRF1.

Referring to FIG. 5d, the finished first reel REEL1 may be removed from the winding device 600, and a new core COR1′ may be mounted to the position of the axis AX11. At the same time, the moving laminate WEB1 may be continuously wound on the second reel REEL2.

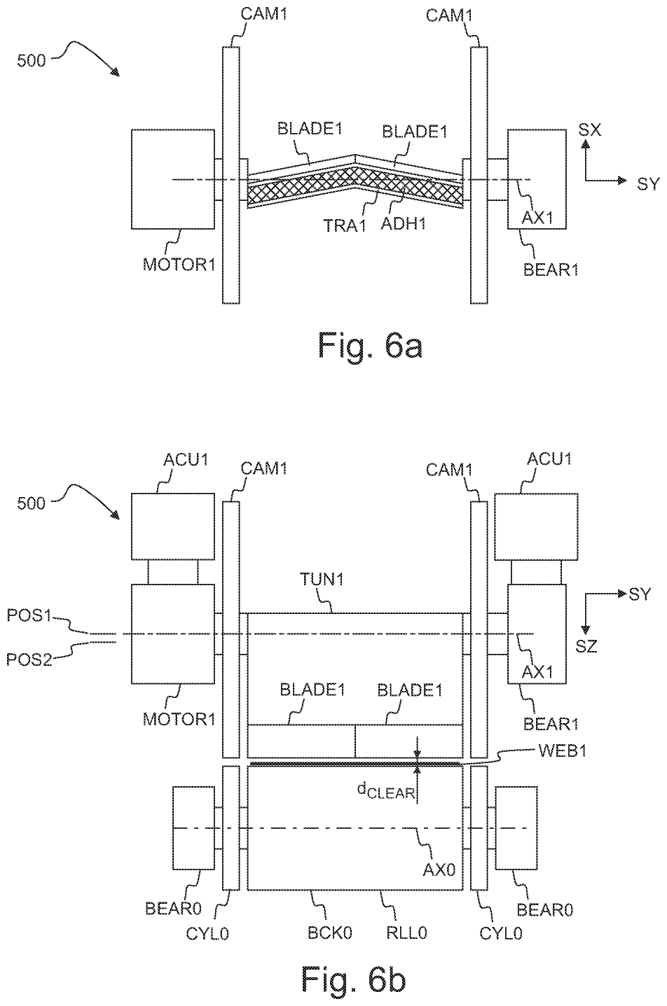

Referring to FIG. 6a, the transfer device 500 may optionally comprise one or more eccentric actuating elements CAM1 to push the rotation axis AX1 away from the cutting position POS2 after the perforation PRF1 has been formed. The actuator unit ACU1 may further comprise the one or more eccentric actuating elements CAM1.

The eccentric actuating element CAM1 may be coupled to the transfer unit

TUN1 to rotate together with the transfer unit TUN1. During the perforating operation, the eccentric surface of the actuating element CAM1 may be in contact with a counter element CYL0 such that the rotating actuating element CAM1 may define and change the distance between the axis AX1 and the counter element CYL0. The counter element CYL1 may be e.g. a rotating wheel. The wheel CYL0 may be attached e.g. to the backing roll RLL0.

The rotating transfer unit TUN1 may be supported by bearings BEAR1. The bearings BEAR1 may define the position of the axis AX1. The rotating transfer unit TUN1 may be rotated by one or more motors MOTOR1. The MOTOR1 may comprise one or more bearings (BEAR1).

The rotating backing roll RLL0 may be supported by bearings BEAR0.

FIG. 6b shows the transfer device 500 in a standby state, where the axis AX1 is in the standby position POS1, and the distance between the blade BLADE1 and the moving laminate WEB1 is greater than or equal to a minimum distance z_{CLEAR1}, so as to prevent premature cutting of the laminate WEB1. The minimum distance z_{CLEAR} may be e.g. in the range of 1 mm to 100 mm.

After the transfer unit TUN1 has been accelerated to the target speed, and when the transfer unit TUN1 is in a suitable angular starting position (e.g. when the orientation angle φ in the range of −180° to −90°), the actuator unit ACU1 may push the axis AX1 of the transfer element TUN1 towards the backing roll RLL0 until the eccentric actuating element CAM1 touches the wheel CYL0 of the backing roll RLL0.

When the transfer unit TUN1 is in a suitable angular working position (e.g. when the orientation angle φ in the range of −20° to +20°), the blade BLADE1 may perforate the laminate WEB1, and the transfer surface TRA1 may transfer the adhesive layer ADH1 to the laminate WEB1.

After the blade BLADE1 has penetrated through the laminate WEB1, the eccentric actuating element CAM1 may push the axis AX1 of the transfer unit TUN1 away from the backing roll RLL0. The eccentric actuating element CAM1 may mechanically ensure that the axis AX1 returns back to the standby position. The actuator unit ACU1 may keep the axis AX1 at the standby position POS1 for the next rotations so as to prevent multiple perforations of the laminate WEB1.

FIG. 7a shows the transfer device 500 in the cutting state, where the actuator

ACU1 has moved the axis AX1 to the cutting position POS2. The minimum distance from the axis AX1 to the contacting surface of the eccentric element CAM1 may be equal to R_{MIN}, and the maximum distance from the axis AX1 to the contacting surface of the eccentric element CAM1 may be equal to R_{MIN}+Δz_{CUT}. Δz_{CUT} may be equal to the distance between the standby position

POS1 and the cutting position POS2.

The distance Δz_{CUT} may be selected to provide the minimum distance d_{CLEAR} when the axis AX1 is in the standyby position POS1, and to ensure reliable cutting when the axis AX1 is in the cutting position POS2. The distance Δz_{CUT} may be e.g. in the range of 1 mm to 100 mm, advantageously in the range of mm to 50 mm.

The distance D1 between the axis AX1 and the counter element CYL0 may be determined as a function e_{CAM}(φ) of the angular position 9 of the transfer element TUN1, in a situation where the actuating element CAM1 is in contact with the counter element CYL0.

The minimum value of the function e_{CAM}(9) may be equal to R_{MIN}, when the axis AX1 is in the cutting position POS2. The minimum value of the function e_{CAM}(φ) may be equal to R_{MIN}, when the transfer unit TUN1 has been rotated such that blade BLADE1 penetrates the laminate WEB1. The minimum value of the function e_{CAM}(9) may be equal to R_{MIN}, when the transfer unit TUN1 has been rotated such that the orientation angle φ=0°.

FIG. 7b shows the transfer device 500 in the standby state, where the rotating eccentric actuating element CAM1 has pushed the axis AX1 from the cutting position POS2 back to the standby position POS1. The eccentric actuating element CAM1 may rotate together with the transfer unit TUN1. Rotation of the eccentric actuating element CAM1 may increase the distance D1 between the axis AX1 and the counter element CYL0 from the minimum value R_{MIN} to the maximum value R_{MIN}+Δz_{CUT}. FIG. 7b shows a situation where the transfer unit TUN1 has been rotated to an angular position φ where the distance D1 between the axis AX1 and the counter element CYL0 is at the maximum value R_{MIN}+Δz_{CUT}. The maximum value of the function e_{CAM}(φ) may be equal to R_{MIN}+Δz_{CUT}, when the transfer unit TUN1 has been rotated such that the orientation angle φ=180°.

FIG. 7c shows the transfer device 500 in the standby state, where the transfer unit TUN1 continues rotation after the axis AX1 has been moved back to the standby position POS1. The axis AX1 may be kept at the standby position POS1 after forming the splicing region REG1. The eccentric actuating element CAM1 does not determine the distance D1 between the axis AX1 and the backing roll RLL0 any more after the axis AX1 has been returned back to the standby position POS1. The eccentric actuating element CAM1 is no more in contact with the counter element CYL0 after the axis AX1 has been moved to the standby position POS1. The actuator unit ACU1 may optionally lock the axis AX1 to the standby position POS1, so as to prevent unintentional contact between the transfer unit MEM1 and the moving laminate WEB1. The axis AX1 may be kept at the standby position POS1 e.g. by gravity and/or by the actuator ACU1.

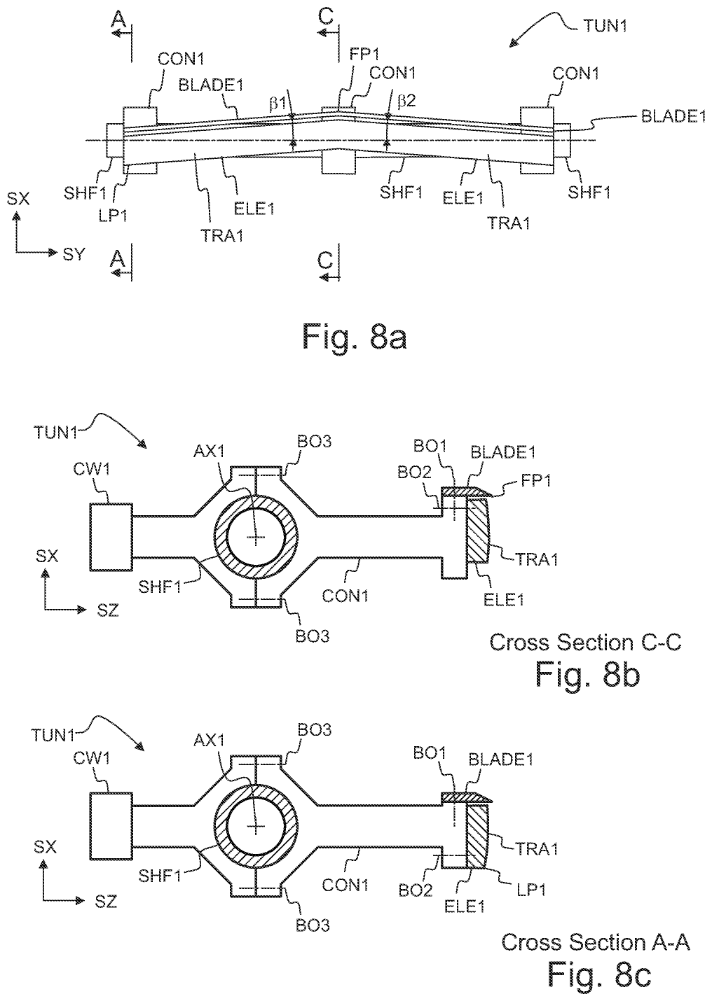

Referring to FIGS. 8a to 8c, the transfer unit TUN1 may comprise a shaft SHF1. The blade BLADE1 may be connected to the shaft SHF1 directly or via one or more connecting elements CON1. The blade BLADE1 may be formed of one or more blade segments.

The transfer unit TUN1 may comprise one or more carrier elements ELE1, which have the curved transfer surface TRA1. The one or more carrier elements ELE1 may be connected to the shaft SHF1 directly or via one or more connecting elements CON1. The transfer surface TRA1 may be removable and/or replaceable. The carrier elements ELE1 may be removable and/or replaceable.

The blade BLADE1 and the carrier elements ELE1 may rotate about the axis AX1 together with the shaft SHF1. The blade BLADE1 and the carrier elements ELE1 may rotate about the axis AX1 together with the shaft SHF1 and the connecting elements CON1.

The blade BLADE1 may be connected to one or more connecting elements CON1 e.g. by using screws BO1. One or more carrier elements ELE1 may be connected to one or more connecting elements CON1 e.g. by using screws

BO2. The one or more connecting elements CON1 may be connected to the shaft SHF1 e.g. by using screws BO3. The transfer unit TUN1 may optionally comprise one or more counterweights CW1 for balancing the rotating masses, to reduce unwanted vibration.

The blade BLADE1 may be inclined, or may comprise inclined portions, so as to facilitate forming the perforation PRF1. β1 may denote an angle between a first portion of the blade BLADE1 and the axis AX1. β2 may denote an angle between a second portion of the blade BLADE1 and the axis AX1. The angle β1 may be e.g. in the range of 2° to 20°. The angle β2 may be e.g. in the range of 2° to 20°.

The shape of the blade BLADE1 and the shape of the transfer surface TRA1 may resemble the latin character “V”, i.e. the blade and/or the transfer surface TRSA1 may be V-shaped.

FP1 denotes a first point of the blade BLADE1 which contacts the laminate WEB1 during a wording time period. The first point FP1 may be e.g. in the middle of the blade BLADE1. LP1 denotes a last point of the transfer surface TRA1, which contacts the laminate WEB1 during said working time period. C-C denotes a first transverse position in the middle of the blade BLADE1. A-A denotes a second transverse position at an end of the blade BLADE1.

FIG. 8b shows, by way of example, the cross section of the transfer unit at the transverse position C-C.

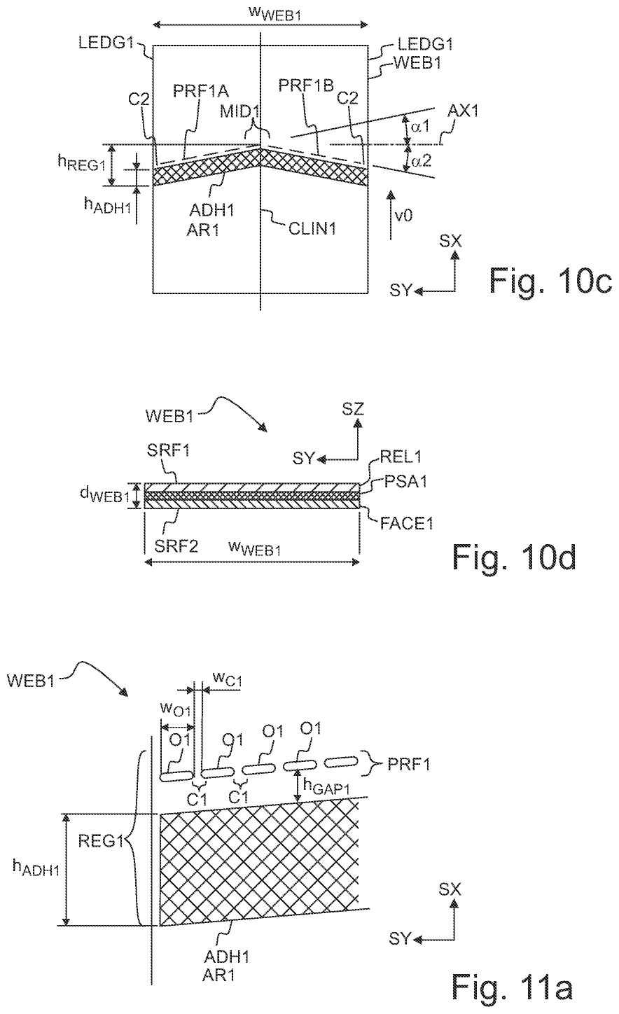

FIG. 8c shows, by way of example, the cross section of the transfer unit at the transverse position A-A. The blade BLADE1 and the transfer surface TRA1 may have the V-shape so that forming the perforation and transfer of the adhesive may be delayed near the longitudinal edges (LEDG1) of the laminate WEB1, when compared with the center (MIDI) of the laminate WEB1 (see also FIG. 10c).

Referring to FIG. 9a, R_{BLADE1} denotes the radial distance of the cutting edge of the blade BLADE1 from the axis AX1. R_{TRA1} denotes the radial distance of the transfer surface TRA1 from the axis AX1. d_{SHF1} denotes a diameter of a shaft SHF1 of the transfer unit TUN1. h_{TRA1} may denote local height of the transfer surface TRA1.

The transfer surface TRA1 may be curved so that the transfer surface TRA1 may roll against the laminate WEB1 during the transfer operation. The radius of curvature of the transfer surface TRA1 may be substantially equal to the radial distance R_{TRA1}. The transfer surface TRA1 may be a portion of a cylindrical surface, which has a radius R_{TRA1}.

Referring to FIG. 9b, the first point FP1 and the last point LP1 may together define an angular height Δϕ_{REG1} of the combination of the blade BLADE1 and the transfer surface TRA1, when viewed from the axis AX1. The first point FP1 is the point, which first contacts the laminate WEB1. The last point LP1 is the point which last contacts the laminate WEB1.

The angular height Δϕ_{REG1} may be e.g. in the range of 2° to 60°, advantageously in the range of 6° to 30°. The angular height Δϕ_{REG1} together with the radial distance R_{TRA1} may determine the height h_{REG1} of the splicing region REG1 formed on the laminate WEB1. The height h_{REG1} may be equal to the length of the laminate WEB1, which is needed for joining the laminate to a reel core (COR1, COR2).

Referring to FIGS. 10a to 10c, the transfer device 500 may form a splicing region REG1 on the moving laminate WEB1. The splicing region REG1 comprises the perforation PRF1 and the region AR1 of the adhesive layer ADH1. w_{WEB1} denotes the width of the laminate WEB1. h_{ADH1} denotes the local length of the adhesive region AR1 in the longitudinal direction of the laminate WEB1.

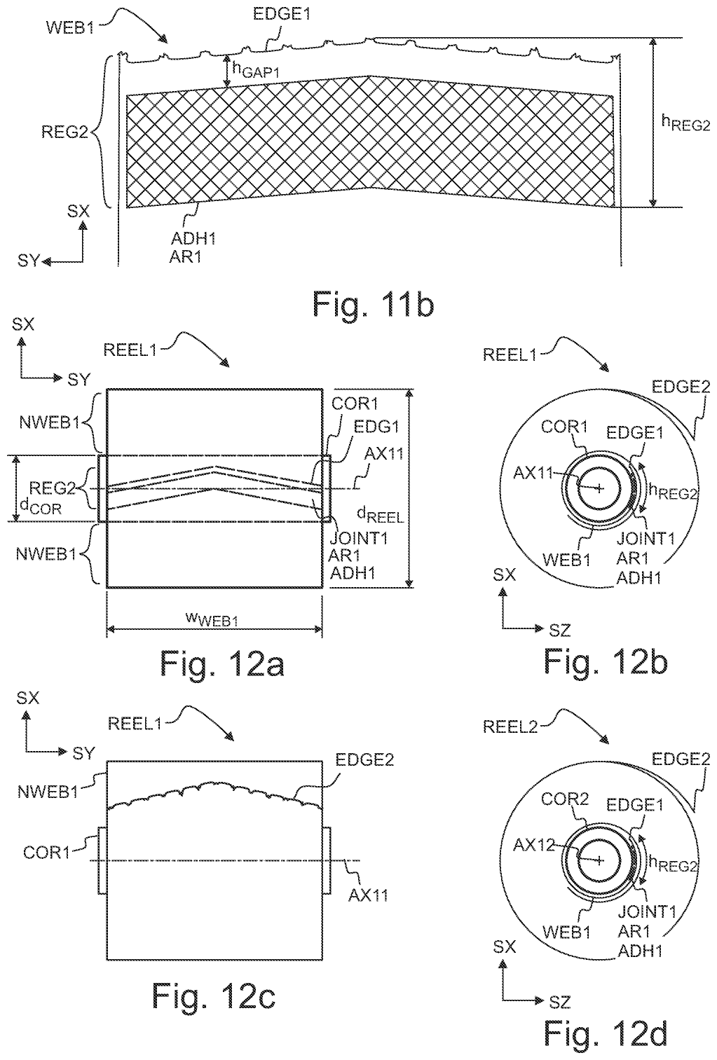

Referring to FIGS. 10a to 11a, the perforation PRF1 may extend over the whole width w_{WEB1} of the laminate WEB1.

Alternatively, the width w_{PRF1} of the perforation PRF1 may be slightly shorter than the width w_{WEB1} of the laminate WEB1. ω_{C2} denotes the width of an intact region C2 at a longitudinal edge LEDG1 of the laminate WEB1.

The splicing region REG1 may comprise an intact region C2 at both longitudinal edges LEDG1 of the laminate WEB1, so as to reduce risk of premature tearing of a longitudinal edge LEDG1 of the laminate WEB1.

Referring to FIG. 10a, the perforation PRF1 may be substantially perpendicular with respect to the longitudinal direction (e.g. SX) of the laminate WEB1. The perforation PRF1 may be substantially parallel with the axis AX1 of the transfer device 500.

Referring to FIG. 10b, the perforation PRF1 may be inclined with respect to the axis AX12 of the reel core COR2 mounted on the winder device 600. α1 may denote an angle between the perforation PRF1 and the axis AX1.

Referring to FIG. 10c, h_{REG1} denotes the total length of the splicing region REG1 in the longitudinal direction (SX) of the laminate WEB1.

The splicing region REG1 may comprise a perforation PRF1, which comprises a first inclined perforated region PRF1A and a second inclined perforated region PRF1B. The first perforated region PRF1A and the second perforated region PRF1b may together form a V-shape, i.e. a shape which resembles the latin character V.

The V-shape may ensure that the perforation PRF1 breaks first at the center MIDI of the laminate WEB1. This may facilitate the splicing operation e.g. as follows:
a force needed to form the perforation with the blade BLADE1 may be reduced,
a tension force F_{TEN} needed to break the perforation PRF1 may be reduced,
a risk of detaching the laminate WEB1 from the reel core COR2 may be reduced, and/or
a risk of premature tearing of a longitudinal edge of the laminate WEB1 may be reduced.

The first perforated region PRF1A has an inclination angle α1 with respect to the axis AX1. The second perforated region PRF1B has an inclination angle α2 with respect to the axis AX1. The angle α1 may be e.g. in the range of 2° to 20°. The angle α2 may be e.g. in the range of 2° to 20°. The angle α2 may be substantially equal to the angle α1 so that the perforation PRF1 may be substantially symmetric with respect to the centerline CLIN1 of the laminate WEB1.

Referring to FIG. 10d, the adhesive label laminate WEB1 may comprise a face layer FACE1, a pressure-sensitive adhesive layer PSA1, and a release liner REL1. The adhesive layer PSA1 may be located between the face layer FACE1 and the release liner REL1. The face layer FACE1 may comprise e.g. plastic film and/or paper. The face layer FACE1 may comprise e.g. polypropylene (PP) or Polyethylene terephthalate (PET). The laminate WEB1 may also be called e.g. as labelstock. The adhesive layer ADH1 may be transferred to the first major surface SRF1 of the laminate WEB1. The first major surface SRF1 may be e.g. on the side of the release liner REL1, wherein the second major surface SRF2 of the laminate WEB2 may be on the side of the face layer FACE1. Alternatively, the major surface SRF1 may be on the side of the face layer FACE1, wherein the second major surface SRF2 may be on the side of the release liner REL1.

The width w_{WEB1} of the laminate WEB1 may be e.g. in the range of 0.2 m to 10 m, typically in the range of 0.5 m to 5 m. d_{WEB1} denotes the thickness of the laminate WEB1. The thickness d_{WEB1} of the laminate WEB1 may be e.g. in the range of 10 μm to 200 μm.

The tension force F_{TEN} per unit width of the laminate WEB1 may be e.g. in the range of 50 N/m to 1000 N/m. The laminate WEB1 may be pulled with a tension force F_{TEN} in the winder device 600. The tension force F_{TEN} may be selected lower than the tensile strength of the laminate WEB1 in order to avoid breaking the un-perforated laminate WEB1. The tension force F_{TEN} may be temporarily and/or locally increased when the adhesive joint JOINT1 starts to rotate with the reel core. The increased tension force F_{TEN} may break the perforation PRF1.

Referring to FIG. 11a, the splicing region REG1 of the laminate WEB1 comprises the perforation PRF1 and the adhesive region AR1. h_{GAP1} denotes a distance between the perforation PRF1 and the adhesive region AR1. The distance h_{GAP1} may be e.g. greater than or equal to 2 mm in order to reduce the risk of contaminating the blade BLADE1 with the adhesive ADH1. The distance h_{GAP1} may be e.g. smaller than or equal to 50 mm in order to reduce the amount of laminate WEB1 needed for joining the laminate WEB1 to a reel core COR1, COR2. The distance h_{GAP1} may be e.g. in the range of 0 mm to 50 mm. The transfer device 500 may be arranged to operate such that the distance h_{GAP1} is e.g. in the range of 0 mm to 50 mm.

The distance h_{GAP1} may be e.g. greater than or equal to 2 mm in order to reduce the risk of contaminating the blade BLADE1 with the adhesive ADH1 and/or in order to reduce risk of leaking of the adhesive ADH1 through the openings O1 of the perforation PRF1. The transfer device 500 may be arranged to operate such that the distance h_{GAP1} is e.g. in the range of 2 mm to 50 mm.

The perforation PRF1 comprises a plurality of adjacent openings O1 separated by intact portions C1. The width w_{O1} of the openings O1 may be e.g. in the range of 2 mm to 100 mm. The width w_{C1} of the intact portions C1 may be e.g. in the range of 5% to 100% of the width w_{O1} of the openings O1.

In particular, the width w_{O1} of the openings O1 may be e.g. in the range of 2 mm to 20 mm, wherein the width w_{C1} of the intact portions C1 may be in the range of 10% to 50% of the width w_{O1} of the openings O1.

Referring to FIG. 11b, the splicing region REG1 may be converted into a broken splicing region REG2 by breaking the perforation PRF1. The broken splicing region REG2 comprises the adhesive region AR1, and the leading edge EDGE1, which was formed by breaking the perforation PRF1. The leading edge EDGE1 may be aligned with the positions of the openings (O1) of the perforation PRF1.

h_{REG2} denotes the total length of the broken splicing region REG2 in the longitudinal direction of the laminate WEB1. The total length h_{REG2} of the broken splicing region REG2 may be substantially equal to the total length h_{REG2} of the splicing region REG1 formed on the laminate WEB1 (FIG. 10c).

The adhesive region AR1 of the broken splicing region REG2 is joined to the reel core COR1, COR2 by the adhesive joint JOINT1. The symbol h_{REG2} may also denote the circumferential length of the broken splicing region REG2 in a reel REEL1, REEL2.

The distance between the leading edge EDGE1 and the adhesive region AR1 may be equal to the distance h_{GAP1} between the perforation PRF1 and the adhesive region AR1. A short distance h_{GAP1} may reduce or avoid creases, which may be caused when subsequent turns of the laminate WEB1 are wound over the leading edge EDGE1. The distance h_{GAP1} may be e.g. in the range of 0 mm to 50 mm, advantageously in the range of 2 mm to 50 mm.

The adhesive region AR1 is formed on the first major surface SRF1, which faces the reel core COR1, COR2. The first major surface SRF1 may be the inner surface, and the second major surface SRF2 may be the outer surface of each wound layer of the laminate WEB1.

FIGS. 12a, 12b, and 12c show by way of example the laminate reel REEL1 produced by the apparatus 1000. The reel REEL1 may comprise several turns NWEB1 of the laminate WEB1 wound on the core COR1.

The reel REEL1 comprises:
a reel core COR1, and
adhesive label laminate WEB1 wound on the reel core COR1,
   wherein a broken splicing region REG2 of the adhesive label laminate WEB1 is joined to the reel core COR1 by an adhesive joint JOINT1,
   wherein the adhesive joint JOINT1 comprises an adhesive ADH1 between the reel core COR1 and an inner major surface SRF1 of the adhesive label laminate WEB1,
   wherein the broken splicing region REG2 comprises an edge EDGE1 formed by breaking a perforation PRF1 of the adhesive label laminate WEB1.

FIG. 12c shows, by way of example, the trailing edge EDGE2 of the laminate WEB1 of the reel REEL1 of FIG. 12a. The trailing edge EDGE2 of the reel REEL1 may be formed by breaking the perforation of the next splicing region REG1. The trailing edge EDGE2 may have a complementary V-shape, which corresponds to the V-shape of the leading edge EDGE1.

FIG. 12d shows, by way of example, a second laminate reel REEL2 produced by the apparatus 1000.

The reel REEL2 comprises:
the reel core COR2, and
the laminate WEB1 wound on the reel core COR2,
   wherein the broken splicing region REG2 of the label laminate WEB1 is joined to the reel core COR2 by the adhesive joint JOINT1,
   wherein the adhesive joint JOINT1 is formed by the adhesive region AR1 between the reel core COR1 and the major surface SRF1 of the laminate WEB1.

The leading edge EDGE1 of the second reel REEL2 and the trailing edge of the first reel REEL1 may be formed by breaking the perforation PRF1 of the splicing region REG1, which is brought into contact with the second reel core COR2.

The reel REEL1 and the REEL2 may comprise e.g. the laminate WEB1 discussed with reference to FIG. 10d.

The circumferential length (h_{REG2}) of the broken splicing region REG2 may be e.g. smaller than 80% of the circumference of the reel core COR1, COR2, advantageously smaller than 50% of the circumference of the reel core.

Thus, the amount of laminate needed for forming the splicing region of the reel REEL1, REEL2 may be reduced.

The circumference of the reel core COR1 is equal to the diameter d_{COR} of the core COR1 multiplied by pi (π≈3.14).

An inclination angle (α1) of the edge EDGE1 may be e.g. in the range of 2° to with respect to the axis (AX11,AX12) of the reel core (COR1,COR2).

The edge EDGE1 may be V-shaped, wherein the inclination angle (α1) of a first portion of the edge EDGE1 may be e.g. in the range of 2° to 20° with respect to the axis AX1 of the reel core COR1.

The diameter of reel core COR1, COR2 may be e.g. in the range of 50 mm to 300 mm. The diameter of the finished reel REEL1, REEL2 may be e.g. in the range of 2 to 10 times the diameter of the reel core COR1, COR2.

The finished reel REEL1, REEL2 may comprise e.g. more than 10 km of laminate WEB1. The weight of a finished reel REEL1, REEL2 may be e.g. 30 greater than 100 kg.

The laminate WEB1 or the face layer FACE1 of the laminate WEB1 may be optionally cut at a later stage to form a plurality of adhesive labels from the laminate WEB1.

The adhesive joint JOINT1 may comprise e.g. hot melt adhesive ADH1.

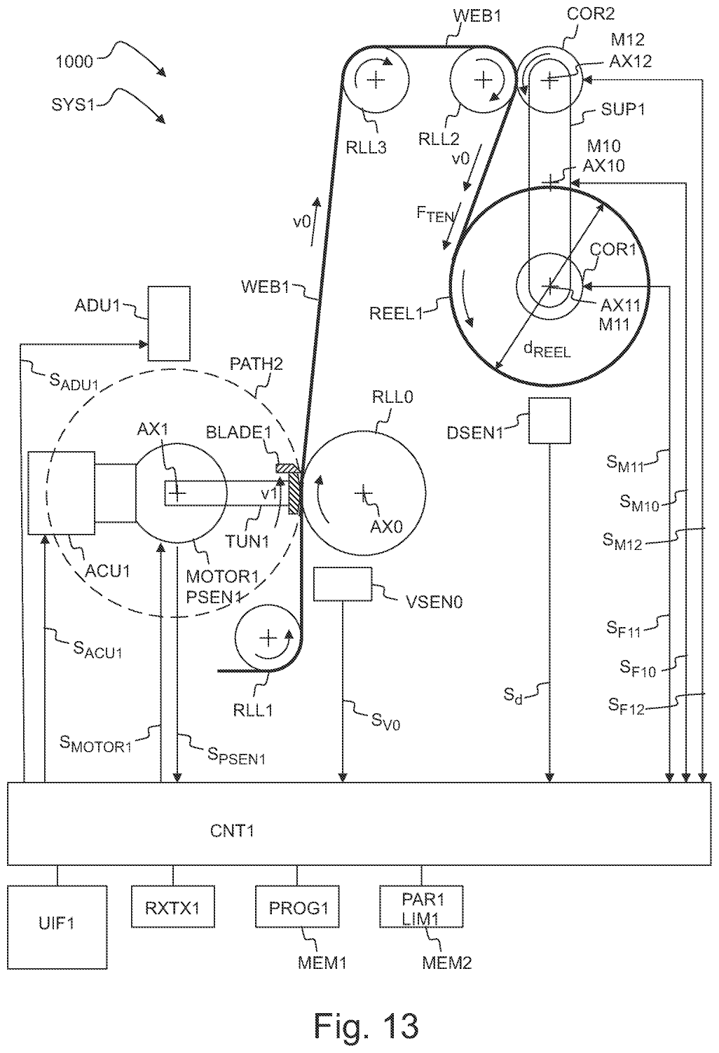

FIG. 13 shows, by way of example, a control system SYS1 for controlling operation of the transfer device 500. The control system SYS1 may also control operation of the winding device 600. The control system SYS1 may control operation of the winding apparatus 1000.

The control system SYS1 may comprise a control unit CNT1 for controlling operation of the motor MOTOR1, the actuator unit ACU1, and the adhesive applicator unit ADU1. The control system SYS1 may provide a signal S_{MOTOR1} for controlling operation of the motor MOTOR1. The control system SYS1 may provide a signal S_{ACU1} for controlling operation of the actuator unit ACU1. The control system SYS1 may provide a signal S_{ADU1} for controlling operation of the adhesive applicator unit ADU1.

The control system SYS1 may comprise a velocity sensor VSENO for monitoring velocity v0 of the laminate WEB1. The velocity sensor VSENO may provide a signal Svo indicative of the velocity v0 of the laminate WEB1. The control system SYS1 may comprise a sensor PSEN1 for monitoring angular position φ of the transfer unit TUN1 and/or for monitoring angular speed ω1 of the transfer unit TUN1. The sensor PSEN1 may provide a signal S_{PSEN1} indicative of the angular position φ of the transfer unit TUN1 and/or indicative of the angular speed ω1 of the transfer unit TUN1.

The control unit CNT1 may control operation of the motor MOTOR1, the actuator unit ACU1, and the adhesive applicator unit ADU1 e.g. based on the signals S_{V0}, S_{PSEN1}.

The method for winding the laminate WEB1 may comprise e.g. one or more of the following method steps:
Driving the motor MOTOR1 so as to rotate the transfer unit TUN1 to a suitable position for applying the adhesive layer ADH1.
Using the adhesive applicator unit ADU1 to apply the adhesive layer ADH1 on the transfer surface TRA1 of the transfer unit TUN1.
Monitoring a reel diameter (d_{REEL}), and starting forming a splicing region REG1 when the reel diameter reaches a predetermined limit value LIM1.
Accelerating rotation of the transfer unit TUN1 with the motor MOTOR1 and controlling the rotation speed ω1 of the transfer unit TUN1 to correspond to the detected velocity v0 of the laminate WEB1.
Using the actuator unit ACU1 to move the axis AX1 from the standby position POS1 to the cutting position POS2. The movement of the axis AX1 may be started when the transfer unit TUN1 rotates at a suitable target speed and when the transfer unit TUN1 is at a suitable initial angular position cp.
Using the actuator unit ACU1 to move the axis AX1 from the cutting position POS2 to the standby position POS1.
Decelerating the rotation speed of the transfer unit TUN1 e.g. by controlling the motor MOTOR1.

The control unit CNT1 may comprise one or more data processors. The control system SYS1 may comprise a memory MEM1 for storing computer program code PROG1. The control system SYS1 may comprise a memory MEM2 for storing operating parameter data PAR1. The control unit CNT1 may be configured to carry out the present method by the executing program code PROG1. The operating parameter data PAR1 may specify e.g. a reel diameter, which automatically triggers forming a splicing region REG1 and initiating a reel change operation.

The control system SYS1 may comprise a user interface UIF1 for receiving user input from a user and/or for providing information to a user. The user interface UIF1 may comprise e.g. a touch screen. For example, a user may initiate forming a splicing region by providing user input via the user interface UIF1.

The control system SYS1 may comprise a communication unit RXTX1 for receiving and/or transmitting data. The communication unit RXTX1 may communicate data e.g. via the Internet, via a wireless communication network and/or via a local communication network.

The control system SYS1 may also control operation of the winding device 600. The winding device 600 may comprise a motor M11 for rotating a core (COR1) about the axis AX11. The winding device 600 may comprise a motor M12 for rotating a core (COR2) about the axis AX12. The winding device 600 may comprise a motor M10 for interchanging the positions of the axes AX11, AX22, e.g. by rotating a support SUP1 about an axis AX10.

The control system SYS1 may provide a signal S_{M10} for controlling operation of the motor M10. The control system SYS1 may provide a signal S_{M11} for controlling operation of the motor M11. The control system SYS1 may provide a signal S_{M12} for controlling operation of the motor M12.

The control system SYS1 may provide a feedback signal S_{F10} indicative of the angular position of the support SUP1. The control system SYS1 may provide a feedback signal SF11 indicative of the angular speed and/or torque of the motor M11. The control system SYS1 may provide a feedback signal SF12 indicative of the angular speed and/or torque of the motor M12.

The control system SYS1 may comprise a sensor for monitoring tension (F_{TEN}) of the laminate WEB1.

The control system SYS1 may comprise a diameter sensor DSEN1 for monitoring diameter d_{REEL} of a reel. The diameter sensor DSEN1 may provide a signal S_{d} indicative of the diameter d_{REEL} of a reel.

In an embodiment, the reel diameter d_{REEL} and/or tension force F_{TEN} may also be determined from the feedback signal SF11 and/or SF12. The reel circumference may be calculated e.g. by dividing the velocity of the laminate WEB1 by the rotation speed of the reel. The reel diameter is equal to the reel circumference divided by pi (π≈3.14). The tension force F_{TEN} may be proportional to the torque of the motor M11 or M12, so that the tension force F_{TEN} may be calculated from the measured torque of the motor by using information about the reel diameter d_{REEL}.

The method may comprise winding the laminate WEB1 to form a reel REEL1, measuring a diameter d_{REEL} of the reel REEL1, and starting forming a splicing region REG1 when the measured diameter d_{REEL} becomes greater than or equal to a predetermined limit value LIM1.

The method may comprise controlling operation of motor M11, M12 so as to keep the tension force F_{TEN} of the laminate WEB1 within a predetermined range. The tension force F_{TEN} may refer to the tension force F_{TEN} of the laminate WEB1 at a position which is between the core COR2 and the reel REEL1.

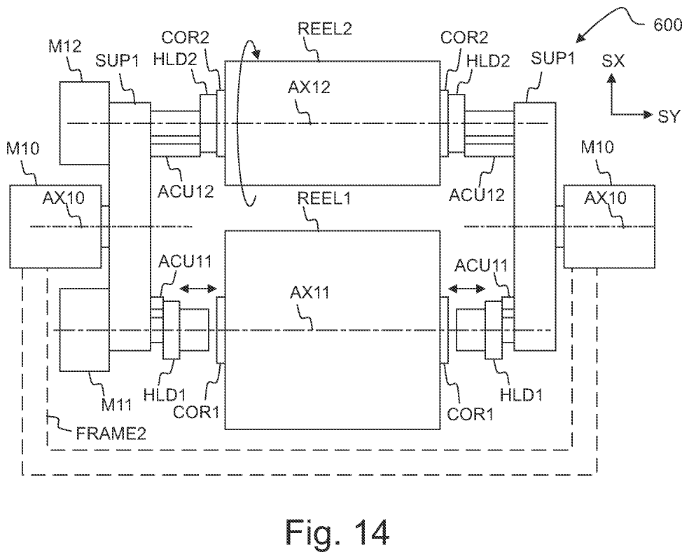

Referring to FIG. 14, the winding device 600 of the apparatus 1000 may be e.g. a turret winder, which enables simultaneous change of positions of the axes AX11, AX12 of the reel cores COR1, COR2. The positions of the axes AX11, AX12 of the reel cores COR1, COR2 may be changed when both reel cores COR1, COR2 are rotated about the axes AX11, AX12, so as to enable forming the joint JOINT1 between the moving laminate WEB1 and the second reel core COR2 when the moving laminate WEB1 is wound on the first reel REEL1. The positions of the axes AX11, AX12 may be changed simultaneously e.g. by rotating one or more supports SUP1 about an axis AX10. The positions of the axes AX11, AX12 may be moved e.g. with respect to a frame FRAME2 of the winding device 600.

The winding device 600 may comprise one or more first holders HLD1 for holding and rotating the first reel core COR1 of the first reel REEL1. A reel core COR1 may be mounted on the holders HLD1.

The winding device 600 may comprise one or more actuators ACU11 for releasing the reel REEL1 from the holders HLD1, at the same time when rotation of the second reel REEL2 about the axis AX12 is continued.

The winding device 600 may comprise one or more second holders HLD2 for holding and rotating the second reel core COR2 of the second reel REEL2. A reel core COR2 may be mounted on the holders HLD2.

The winding device 600 may comprise one or more actuators ACU12 for releasing the reel REEL2 from the holders HLD2, at the same time when the first reel REEL1 continues rotation about the axis AX11.

The supporting elements SUP1 of the winder device 600 may also comprise holders (HLD1, HLD2) for simultaneously holding cores (COR1, COR2, COR1′) of three or more reels.

Various aspects of the invention are illustrated by the following examples:

Example 1. An apparatus (1000) for producing reels (REEL1, REEL2) of label laminate (WEB1), the apparatus (1000) comprising a transfer device (500), the transfer device (500) comprising:
a transfer unit (TUN1), which comprises a perforating blade (BLADE1), and a transfer surface (TRA1),
an adhesive applicator unit (ADU1) for providing an adhesive layer (ADH1) on the transfer surface (TRA1) of the transfer unit (TUN1),
a motor (MOTOR1) to rotate the transfer unit (TUN1) about a first rotation axis (AX1),
an actuator unit (ACU1) to move the first rotation axis (AX1) from a standby position (POS1) to a cutting position (POS2),
   wherein the transfer device (500) is arranged to form a perforation (PRF1) in the label laminate (WEB1) by cutting with the blade (BLADE1) of the rotating transfer unit (TUN1) when the first rotation axis (AX1) is in the cutting position (POS2),
   wherein the transfer device (500) is arranged to form an adhesive region (AR1) on the label laminate (WEB1) by pressing the transfer surface (TRA1) of the rotating transfer unit (TUN1) onto the label laminate (WEB1) such that the adhesive layer (ADH1) is transferred to the label laminate (WEB1), and
   wherein the transfer device (500) is arranged to move the first rotation axis (AX1) back to the standby position (POS1).

Example 2. The apparatus (1000) of example 1, wherein the transfer device (500) is arranged to form the perforation (PRF1) and to transfer the adhesive layer (ADH1) during a working time period (TwonKi) which is shorter than a time period (Mori) of one complete rotation of the transfer unit (TUN1).

Example 3. The apparatus (1000) of example 1 or 2, wherein the apparatus (1000) is arranged to form the adhesive region (AR1) such that the distance (h_{GAP1}) between the perforation (PRF1) and the adhesive region (AR1) is in the range of 2 mm to 50 mm.

Example 4. The apparatus (1000) according to any of the examples 1 to 3, wherein the perforating blade (BLADE1) is arranged to form the perforation (PRF1) such that the perforation (PRF1) comprises one or more inclined perforated portions (PRF1A,PRF1B), which are inclined with respect to the first rotation axis (AX1).

Example 5. The apparatus (1000) according to any of the examples 1 to 4, comprising a backing roll (RLL0) to operate as a backing for the perforating blade (BLADE1).

Example 6. The apparatus (1000) according to any of the examples 1 to 5, wherein the adhesive applicator unit (ADU1) is arranged to form the adhesive layer (ADH1) from a hot melt adhesive.

Example 7. The apparatus (1000) according to any of the examples 1 to 6, comprising an eccentric actuating element (CAM1) to push the first rotation axis (AX1) away from the cutting position (POS2) after forming the perforation (PRF1), wherein the eccentric actuating element (CAM1) is coupled to rotate together with the transfer unit (TUN1).

Example 8. The apparatus (1000) according to any of the examples 1 to 7, comprising a winder device (600) to form a first reel (REEL1) by winding the label laminate (WEB1) on a first reel core (COR1), and subsequently to form a second reel (REEL2) by winding the label laminate (WEB1) on a second reel core (COR2).

Example 9. The apparatus (1000) of example 8, wherein the winder device (600) is arranged to press the label laminate (WEB1) against the second reel core (COR2) so as to form an adhesive joint (JOINT1) between the adhesive layer (ADH1) of the label laminate (WEB1) and the second reel core (COR2).

Example 10. The apparatus (1000) of example 9, wherein the adhesive joint (JOINT1) is arranged to break the perforation (PRF1) so that a leading edge (EDGE1) of the label laminate (WEB1) starts to rotate together with the second core (COR2), wherein a trailing edge (EDGE2) of the label laminate (WEB1) is pulled to the first reel (REEL1).

Example 11. A method for producing reels (REEL1, REEL2) of label laminate (WEB1) by using a transfer unit (TUN1), which comprises a perforating blade (BLADE1), and a transfer surface (TRA1), the method comprising:
providing an adhesive layer (ADH1) on the transfer surface (TRA1) of the transfer unit (TUN1),
rotating the transfer unit (TUN1) about a first rotation axis (AX1),
moving the first rotation axis (AX1) from a standby position (POS1) to a cutting position (POS2),
forming a perforation (PRF1) in the label laminate (WEB1) by cutting with the blade (BLADE1) of the rotating transfer unit (TUN1) when the first rotation axis

(AX1) is in the cutting position (POS2),
forming an adhesive region (AR1) on the label laminate (WEB1) by pressing the transfer surface (TRA1) of the rotating transfer unit (TUN1) onto the label laminate (WEB1) such that the adhesive layer (ADH1) is transferred to the label laminate (WEB1), and
moving the first rotation axis (AX1) back to the standby position (POS1).

Example 12. The method of example 11, comprising:
forming a first reel (REEL1) by winding the label laminate (WEB1) on a first reel core (COR1),
forming an adhesive joint (JOINT1) by bringing the adhesive region (AR1) into contact with a rotating second reel core (COR2) when the label laminate (WEB1) is wound on the first reel (REEL1),
breaking the perforation (PRF1), and
forming a second reel (REEL2) by winding the label laminate (WEB1) on the second reel core (COR1), wherein the second reel REEL2 comprises the adhesive joint JOINT1 and a leading edge EDGE1 formed by breaking the perforation PRF1.

Example 13. The method of example 11 or 12, comprising winding the laminate (WEB1) to form a reel (REEL1), measuring a diameter d_{REEL} of the reel (REEL1), and starting forming a splicing region (REG1) when the measured diameter d_{REEL} becomes greater than or equal to a predetermined limit value (LIM1).

Example 14. A reel (REEL1), comprising:
a reel core (COR1), and
a label laminate (WEB1) wound on the reel core (COR1),
   wherein a broken splicing region (REG2) of the label laminate (WEB1) is joined to the reel core (COR1) by an adhesive joint (JOINT1),
   wherein the adhesive joint (JOINT1) is formed by an adhesive region (AR1) between the reel core (COR1) and a major surface (SRF1) of the label laminate (WEB1), wherein the broken splicing region (REG2) comprises the adhesive region (AR1), and wherein the broken splicing region (REG2) comprises an edge (EDGE1) formed by breaking a perforation (PRF1) of the label laminate (WEB1).

Example 15. The reel (REEL1) of example 14, wherein the circumferential length (h_{REG2}) of the broken splicing region (REG2) is smaller than 80% of the circumference of the reel core (COR1).

Example 16. The reel (REEL1) of example 14 or 15, wherein an inclination angle (α1) of the edge (EDGE1) is in the range of 2° to 20° with respect to the axis (AX11) of the reel core (COR1).

Example 17. The reel (REEL1) according to any of the examples 14 to 16, wherein the diameter (d_{COR}) of the reel core (COR1) is in the range of 50 mm to 300 mm, and the diameter (d_{REEL}) of the reel (REEL1) is in the range of 2 to 10 times the diameter (d_{COR}) of the reel core (COR1).

Example 18. The reel (REEL1) according to any of the examples 14 to 17, wherein the adhesive joint (JOINT1) comprises hot melt adhesive (ADH1).

For the person skilled in the art, it will be clear that modifications and variations of the devices and methods according to the present invention are perceivable. The figures are schematic. The particular embodiments described above with reference to the accompanying drawings are illustrative only and not meant to limit the scope of the invention, which is defined by the appended examples.

1. An apparatus for producing reels of adhesive label laminate, the apparatus comprising a transfer device, the transfer device comprising:
a transfer unit, which comprises a perforating blade, and a transfer surface,
an adhesive applicator unit for providing an adhesive layer on the transfer surface,
a motor to rotate the transfer unit about a first rotation axis,
an actuator unit to move the first rotation axis from a standby position to a cutting position,
wherein the transfer device is arranged to form a perforation in the label laminate by cutting with the blade of the rotating transfer unit when the first rotation axis is in the cutting position,
wherein the transfer device is arranged to form an adhesive region on the label laminate by pressing the transfer surface of the rotating transfer unit onto the label laminate such that the adhesive layer is transferred to the label laminate, wherein the transfer device is arranged to move the first rotation axis back to the standby position.

2. The apparatus of claim 1, wherein the transfer device is arranged to form the perforation and to transfer the adhesive layer during a working time period, which is shorter than a time period of one complete rotation of the transfer unit.

3. The apparatus of claim 1, wherein the apparatus is arranged to form the adhesive region such that the distance between the perforation and the adhesive region is in the range of 2 mm to 50 mm.

4. The apparatus of claim 1, wherein the perforating blade is arranged to form the perforation such that the perforation comprises one or more inclined perforated portions, which are inclined with respect to the first rotation axis.

5. The apparatus of claim 1, comprising a backing roll to operate as a backing for the perforating blade.

6. The apparatus of claim 1, wherein the adhesive applicator unit is arranged to form the adhesive layer from a hot melt adhesive.

7. The apparatus of claim 1, comprising an eccentric actuating element to push the first rotation axis away from the cutting position after forming the perforation, wherein the eccentric actuating element is coupled to rotate together with the transfer unit.

8. The apparatus of claim 1, comprising a winder device to form a first reel by winding the label laminate on a first reel core, and subsequently to form a second reel by winding the label laminate on a second reel core.

9. The apparatus of claim 8, wherein the winder device is arranged to press the label laminate against the second reel core so as to form an adhesive joint between the adhesive layer of the label laminate and the second reel core.

10. The apparatus of claim 9, wherein the adhesive joint is arranged to break the perforation so that a leading edge of the label laminate starts to rotate together with the second core, wherein a trailing edge of the label laminate is pulled to the first reel.

11. A method for producing reels of adhesive label laminate by using a transfer unit, which comprises a perforating blade, and a transfer surface, the method comprising:
providing an adhesive layer on the transfer surface of the transfer unit,
rotating the transfer unit about a first rotation axis,
moving the first rotation axis from a standby position to a cutting position,
forming a perforation in the label laminate by cutting with the blade of the rotating transfer unit when the first rotation axis is in the cutting position,
forming an adhesive region on the label laminate by pressing the transfer surface of the rotating transfer unit onto the label laminate such that the adhesive layer is transferred to the label laminate, and
moving the first rotation axis back to the standby position.

12. The method of claim 11, comprising:
forming a first reel by winding the label laminate on a first reel core,
forming an adhesive joint by bringing the adhesive region into contact with a rotating second reel core when the label laminate is wound on the first reel,
breaking the perforation, and
forming a second reel by winding the label laminate on the second reel core,
wherein the second reel comprises the adhesive joint and a leading edge formed by breaking the perforation.

13. The method of claim 11, comprising winding the laminate to form a reel, measuring a diameter of the reel, and starting forming a splicing region when the measured diameter becomes greater than or equal to a predetermined limit value.

14. A reel, comprising:
a reel core, and
a label laminate wound on the reel core,
wherein a broken splicing region of the label laminate is joined to the reel core by an adhesive joint,
wherein the adhesive joint is formed by an adhesive region between the reel core and a major surface of the label laminate, wherein the broken splicing region comprises the adhesive region, and wherein the broken splicing region comprises an edge formed by breaking a perforation of the label laminate.

15. The reel of claim 14, wherein the circumferential length of the broken splicing region is smaller than 80% of the circumference of the reel core.

16. The reel of claim 14, wherein an inclination angle of the edge is in the range of 2° to 20° with respect to the axis of the reel core.

17. The reel of claim 14, wherein the diameter of the reel core is in the range of 50 mm to 300 mm, and the diameter of the reel is in the range of 2 to 10 times the diameter of the reel core.

18. The reel of claim 14, wherein the adhesive joint comprises hot melt adhesive.
